(19) United States
(12) Patent Application Publication
(10) Pub. No.: US 2026/0343181 A1
(43) Pub. Date: Oct. 29, 2026

(54) APPARATUS AND METHODS FOR CONTACTLESS CARD ASSISTED LOCATION DETERMINATION

(71) Applicant: Capital One Services, LLC, McLean, VA (US)

(72) Inventors: David Kelly Wurmfeld, Melbourne, FL (US); Srinivasa Chigurupati, Long Grove, IL (US); Kevin Osborn, Newton Highlands, MA (US)

(73) Assignee: Capital One Services, LLC, McLean, VA (US)

(21) Appl. No.: 19/191,817

(22) Filed: Apr. 28, 2025

(51) Int. Cl. H04W 4/029; G06F 21/35; G06F 21/60; G07C 9/00

(52) U.S. Cl. CPC H04W 4/029; G06F 21/35; G06F 21/602; G07C 9/00182; G07C 2009/0019

(57) ABSTRACT

Disclosed herein is a method for contactless card assisted location determination. The method includes receiving, at a processor of a mobile device, a request to identify a location of the mobile device. Causing, by the processor, a prompt to be displayed on the mobile device to tap a contactless card associated with a user account to the mobile device based on the request. Receiving, by the processor, encrypted data from the contactless card based on the contactless card being within a communication range of the mobile device The processor then gathers location data of the mobile device from one or more electrical components in proximity of the mobile device. The encrypted data from the contactless card and the location data is then sent to one or more servers to verify the encrypted data and determine the location of the mobile device within an area based on the location data.

### FIELD OF THE DISCLOSURE

The present disclosure relates to location determination methods and devices. More particularly, the present disclosure relates to contactless card assisted location determination in emergency and other situations.

### BACKGROUND

Computing devices such as mobile devices, smart phones, tablet computers, and the like can determine their own location, and therefore the location of a user currently possessing the computing device. The devices use various means such as onboard Global Positioning Systems (GPS) and cellular location positioning to determine the location thereof. However, these methods have limitations. For example, atmospheric conditions, signal blockage, and other issues can cause the location of the computing device determined by GPS and cellular location positioning to be quite inaccurate or at least not a precise as desired for some applications. Moreover, these signals may not work properly in tall buildings or during emergency situations.

Additionally, during emergency situations, such as during active shooter situations, during a fire or some other environmental tragedy, it may be necessary to verify an identity of a user associated with the computing device and not just the location of the user and their computing device.

There is therefore a need to address some of the above deficiencies for determining location information of a user and provide solutions that improve security, location determination, and emergency response and preparedness.

### BRIEF SUMMARY

In one aspect, a method for contactless card assisted location determination is provided. In some embodiments, the method includes receiving, at a mobile device, a request to identify a location of the mobile device, the request causing a prompt to be displayed on the mobile device to tap a contactless card associated with a user account to the mobile device. Receiving, by the mobile device, encrypted data from the contactless card based on the contactless card being within a communication range of the mobile device. The method further includes gathering, by the mobile device, location data of the mobile device from one or more electrical components in proximity of the mobile device. The method further includes sending, by the mobile device, the encrypted data from the contactless card and the location data to one or more servers to verify the encrypted data and determine the location of the mobile device within an area based on the location data.

In another aspect, a server for contactless card assisted location determination is provided. The server includes a memory storing executable instructions and a processing circuit to execute the instructions, which when executed cause the processing circuit to perform various operations. In some embodiments, the processing circuit is caused to send, to a mobile device, a request to identify a location of the mobile device within an area, the request configured to cause a prompt to be displayed on the mobile device to tap a contactless card associated with a user to the mobile device, where the contactless card is to send encrypted data to the mobile device during the tap. In some embodiments, the processing circuit is caused to receive from the mobile device location data thereof, and communicate with an authentication server that the encrypted data is authenticated. In some embodiments, the processing circuit is caused to determine, based on the location data, a location of the mobile device within the area. In some embodiments, the processing circuit is caused to store on the server the location of the mobile device.

In another aspect, another method for contactless card assisted location determination is provided. In some embodiments, the method includes sending, by a location server, to a mobile device a request to identify a location of the mobile device, the request configured to cause a prompt to be displayed on the mobile device to tap a contactless card associated with a user to the mobile device, where the contactless card is to send encrypted data to the mobile device for forwarding to an authentication server. In some embodiments, the method includes receiving from the mobile device location data thereof. In some embodiments, the method includes receiving from the authentication server an indication that the encrypted data has been validated along with an identity of a user associated with the contactless card. In some embodiments, the method includes analyzing, by the location server, the location data to determine a location of the mobile device within an area. In some embodiments, the method includes determining, by the location server, instructions for navigating within the area from the location of the mobile device to a second location. In some embodiments, the method includes sending, by the location server, the instructions to the mobile device for display to the user.

Non-transitory computer program products (e.g., physically embodied computer program products) are also described that store instructions, which, when executed by one or more data processors (e.g., processor circuit) of one or more computing systems, cause at least one data processor to perform operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE SEVERAL VIEWS OF THE DRAWINGS

Provided below is a brief description of the several views of the drawings which illustrate various aspects of some embodiments of the present disclosure. The various drawings are described in more detail in the Detailed Description that follows. To easily identify the discussion of any particular element or act, the most significant digit or digits in a reference number refer to the figure number in which that element is first introduced.

FIG. 1 is a network diagram of a system in accordance with one embodiment.

FIG. 2 is a block diagram of a computing device in accordance with one embodiment.

FIG. 3A illustrates an example location determination environment in accordance with one embodiment.

FIG. 3B illustrates an example message including location data in accordance with one embodiment.

FIG. 3C illustrates an example location determination environment in accordance with one embodiment.

FIG. 4A illustrates an example location determination environment in accordance with one embodiment.

FIG. 4B illustrates an example location determination environment in accordance with one embodiment.

FIG. 5 illustrates a contactless card in accordance with one embodiment.

FIG. 6 illustrates a transaction card component in accordance with one embodiment.

FIG. 7 illustrates an example method in accordance with one embodiment.

FIG. 8 illustrates an example method in accordance with another embodiment.

FIG. 9 illustrates a sequence flow in accordance with one embodiment.

FIG. 10 illustrates an example of a system configured to operate in accordance with embodiments discussed herein.

FIG. 11 illustrates a DNS sequence flow in accordance with one embodiment.

FIG. 12A illustrates a sequence flow of communications between various devices in accordance with one embodiment.

FIG. 12B illustrates a sequence flow of communications between various devices in accordance with one embodiment.

FIG. 12C illustrates a sequence flow of communications between various devices in accordance with one embodiment.

FIG. 13 illustrates a message format in accordance with one embodiment.

FIG. 14 is a flow chart illustrating various operations of an example method in accordance with one embodiment.

FIG. 15 illustrates a network diagram in accordance with one embodiment.

FIG. 16 is a flow chart illustrating various operations of an example method in accordance with one embodiment.

### DETAILED DESCRIPTION

Described herein are techniques, systems, and methods for contactless card-assisted location determination. In some instances, contactless card functions discussed herein may be utilized in a multi-issuer computing environment. These functions may include tap-to functions where a user may tap their contactless card on a device, such as a mobile device, to perform a function. Some situations, such as emergency response situations, active shooter events, and other environments, it may be desirable to determine the location of a person within an area and verify their identity at the same time. One example situation involves one or more people being located in a high-rise building or other area where cellular and global positioning system (GPS) services are such that location determination of a person with a mobile device is not very accurate. It may be desirable to determine the location of people so that emergency response personnel can determine who is in the area and what their current location is. This is also helpful in active shooter situations where it may be helpful to determine where known individuals are in relation to the shooter.

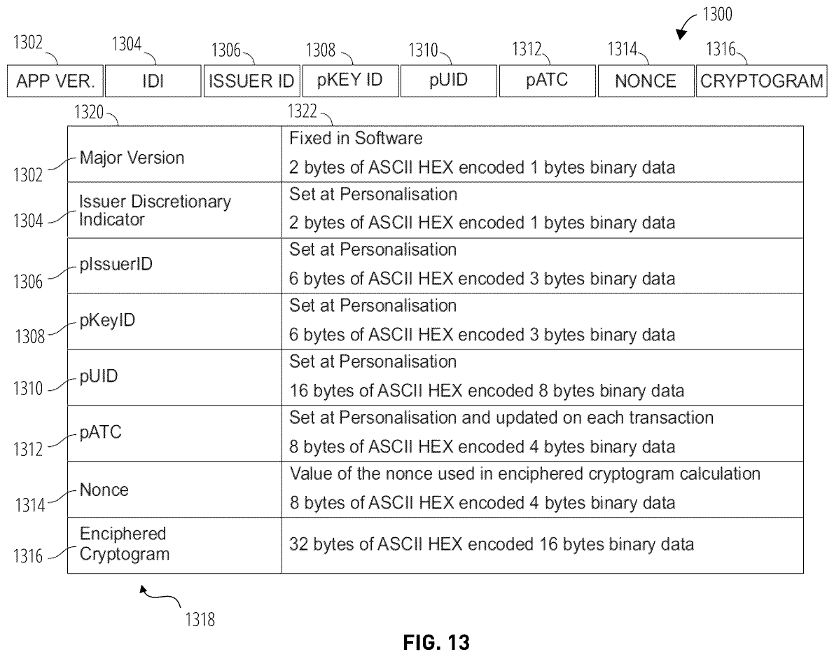

In some embodiments, the mobile device of a person in the area receives a request to identify a location thereof. After, a prompt is displayed on the mobile device to tap a contactless card associated with the person to their mobile device. A message, such as message 1300 from FIG. 13 below is sent from the contactless card to the mobile device and includes encrypted data and a unique customer identifier that is unique to the contactless card and identifies the person in possession of the card. The message from the contactless card is received by the mobile device and forwarded to an authentication server that verifies the customer identifier and sends a message to a location determination server that the identity of the person is verified based on the customer identifier received in the message.

In addition, location data from the mobile device is sent to location determination server. Based on the identity of the person being verified using the contactless card, and using the location information from the mobile device, the location determination server can determine the location of the mobile device and associate that location with the user of the mobile device and contactless card. With this information, the location determination server can send the mobile device instructions detailing how the user can get to a specific location different than their current location (e.g., the location of emergency exit or stairs, or the location of a safe area or room). As described herein, various other details can be sent to the user as well.

Embodiments of the present disclosure represent an improvement in location determination technology over prior systems because prior systems do not allow for quickly and efficiently verifying the identity of the person with the mobile device. Moreover, the embodiments described herein provide an approach that is non-conventional in that, it is not a typical approach to verify one's identity by a contactless card storing and providing a secure token through wireless communication. Typically, in software systems, identity verification is performed using a personal identification number (PIN), password, or other form of identity verification. As such, the disclosed embodiments provide a non-conventional technical improvement or solution to a technical problem experienced with existing systems.

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

The systems discussed here may enable users to perform these functions in a multi-issuer environment. Further, the systems discussed herein enable card issuers or payment providers, such as banks, to issue contactless cards with tap-to functions to customers while maintaining high-level security. The systems and methods discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain. However, the embodiments discussed enable issuers to offload much of the processing, storage, and security functionality to a neutral or central system. As will be discussed in more detail, the central system is configured to provide contactless card features for multiple issuers while maintaining high security and data integrity. Each issuer's functionality and data may be separately managed and secured such that another issuer cannot access another issuer's data or functions. As will be discussed in more detail, these features may be provided by a switchboard system configured to process and perform each contactless card function securely. Additional benefits for issuers may include providing a highly secure authentication option for mobile web, which typically lacks the robust authentication options available in a native application.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and contactless card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and contactless cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

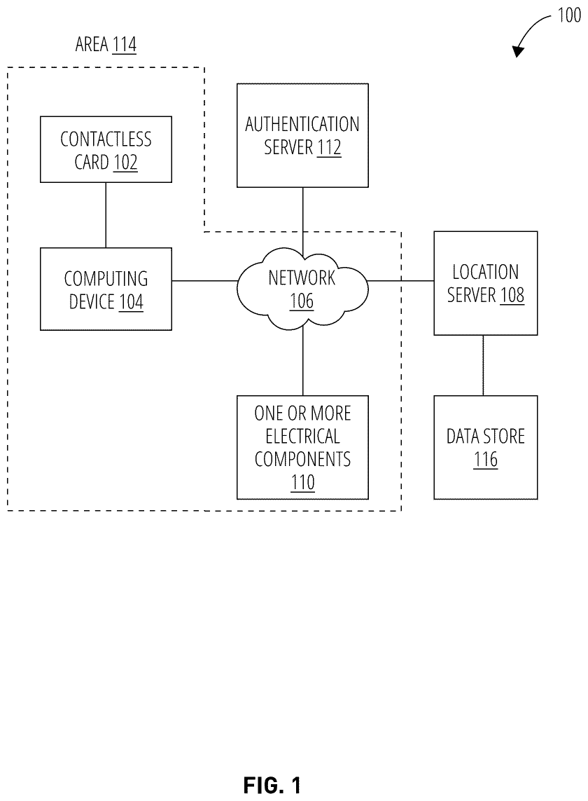

FIG. 1 is a network diagram illustrating an example location determination system 100 according to an example embodiment. As further discussed below, location determination system 100 may include contactless card 102, computing device 104, network 106, location server 108, one or more electrical components 110, and authentication server 112. Although FIG. 1 illustrates single instances of the components, location determination system 100 may include any number of components.

Location determination system 100 may include one or more contactless cards 102, which are further explained below. In some embodiments, contactless card 102 may be in wireless communication, utilizing near field communication (NFC), wireless fidelity (Wi-Fi), Bluetooth®, or any other suitable wireless communications protocol in an example, with computing device 104.

Location determination system 100 may include computing device 104, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. computing device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The computing device 104 device can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The computing device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, computing device 104 of location determination system 100 may execute one or more applications, such as software applications, that enable, for example, network communications with one or more components of location determination system 100 and transmit and/or receive data.

The computing device 104 may be in communication with one or more devices such as the one or more electrical components 110, location server 108, and authentication server 112 via one or more network(s) 106, and may operate as a respective front-end to back-end pair with location server 108. In this embodiment, the computing device 104 operates an application, and the location server 108 acts as an application server for the application that is being executed on the computing device 104. The computing device 104 may transmit, for example from a mobile device application executing on computing device 104, one or more requests to location server 108. The one or more requests may be associated with retrieving data from location server 108. The location server 108 may receive the one or more requests from computing device 104. Based on the one or more requests from computing device 104, location server 108 may be configured to retrieve the requested data from one or more databases (not shown). Based on receipt of the requested data from the one or more databases, location server 108 may be configured to transmit the received data to computing device 104, the received data being responsive to one or more requests.

Alternatively, the location server 108 can send requests to the computing device 104. For example, the location server 108 can send a request to the computing device 104 requesting location information from the computing device 104. The computing device 104 can gather location data as described herein and send it to the location server 108 in response to the request. The location server 108 can then analyze the location data from the computing device 104 and determine the location of the computing device 104 (and therefore the person with possession of the computing device 104) within an area 114.

Location determination system 100 may include one or more networks 106. In some examples, network 106 may be one or more of a wireless network, a wired network or any combination of wireless network and wired network, and may be configured to connect computing device 104 to location server 108. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth®, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. network 106 may further include one network, or any number of the exemplary types of networks mentioned above, operating as a stand-alone network or in cooperation with each other. network 106 may utilize one or more protocols of one or more network elements to which they are communicatively coupled. network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

Location determination system 100 may include one or more location servers 108. In some examples, location server 108 may include one or more processors, which are coupled to memory. The location server 108 may be configured as a central system, server or platform to control and call various data at different times to execute a plurality of workflow actions. Location server 108 may be configured to communicate with one or more databases stored in a data store 116. The location server 108 may be connected to at least one computing device 104 via the network 106.

The location determination system 100 may further include one or more electrical components 110. The one or more electrical components 110 can include one or more wireless access points (WAPs), one or more radio frequency identification (RFID) or NFC readers, or any other suitable electronic component capable of communicating data (e.g., location data) with the computing device 104.

The location determination system 100 further includes an authentication server 112 configured to receive encrypted data from the computing device 104 and decrypt the encrypted data to verify an identity of the person possessing the computing device 104 and the contactless card 102. The authentication server 112 can comprise a processing circuit coupled with memory to execute various functions described herein.

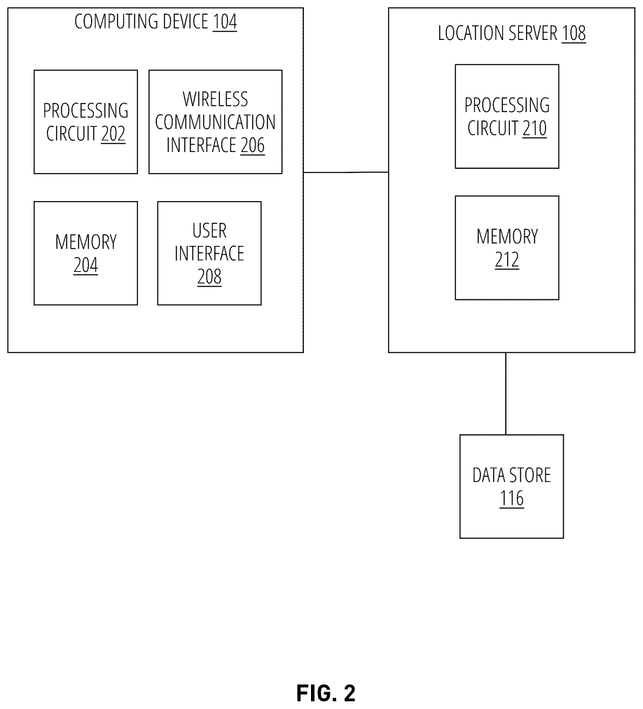

FIG. 2 is a block diagram illustrating various components of an example computing device 104 and the location server 108 according to some implementations.

In some embodiments, the computing device 104 includes a processing circuit 202, memory 204, a wireless communication interface 206, and user interface 208.

In some embodiments, the processing circuit 202 can include single core processor, a multi-core processor, a central processing unit (CPU), a mobile processor, a micro-processor, an application specific integrated circuit (ASIC), or any other suitable processing circuit. The memory 204 can include any suitable volatile or nonvolatile memory, or any combination of the two. For example, the memory 204 can include random access memory (RAM), non-volatile RAM (NVRAM), read only memory (ROM), a hard drive, a solid state drive, or any other suitable memory device or combination of memory devices.

The computing device 104 can include a wireless communication interface 206 such as a Wi-Fi interface or antenna, Bluetooth®, RFID, or any other suitable wireless communication interface 206 or antenna. The wireless communication interface 206 allows the computing device 104 to communicate with the one or more electrical components 110 within the area 114, as described herein. For example, the wireless communication interface 206 can communicate with one or more WAPs located within the area 114 or one or more RFID or NFC readers located within the area 114.

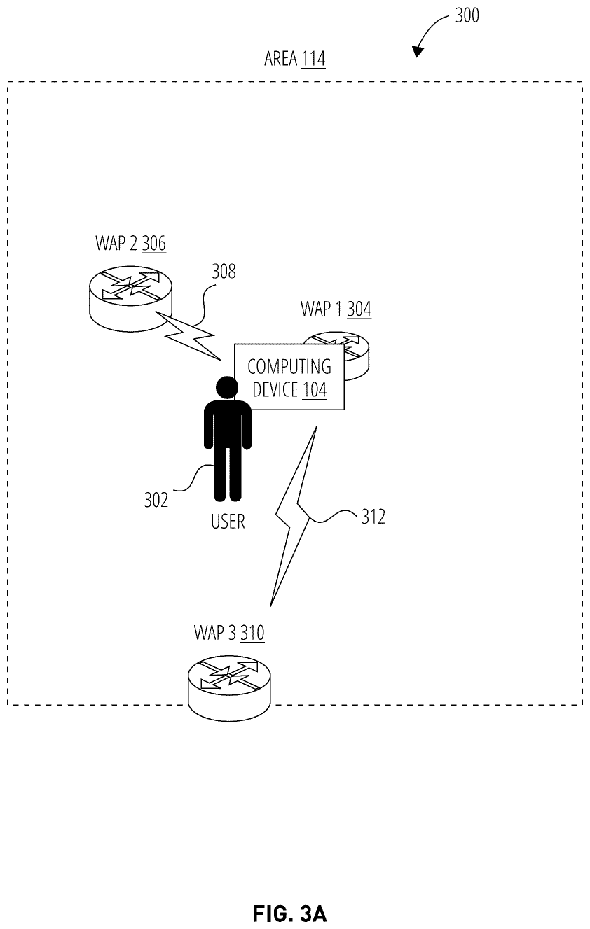

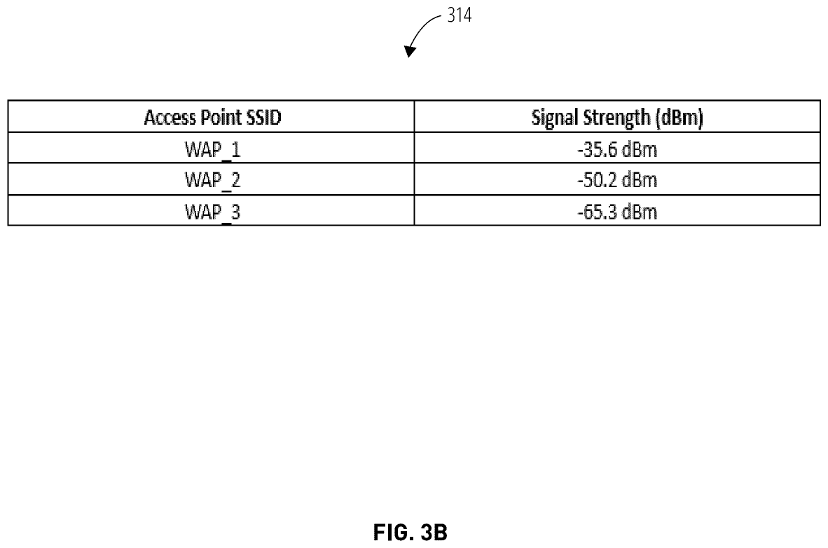

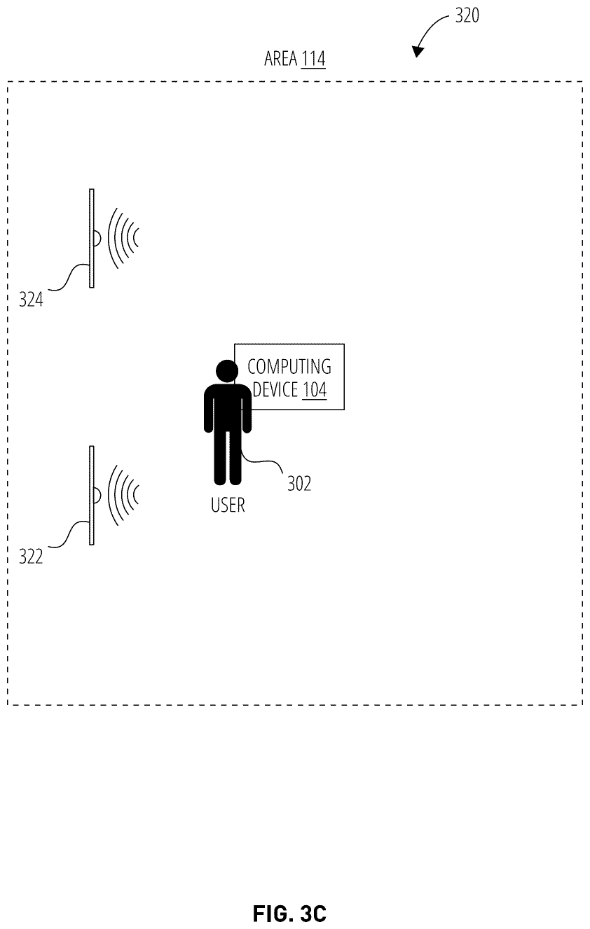

In some embodiments, the wireless communication interface 206 is configured to allow the computing device 104 to communicate with one or more WAPs and also determines a Wi-Fi signal strength with each WAP with which the computing device 104 is connected. For example, the computing device 104 may maintain a list of Wi-Fi service set identifiers (SSIDs) of each WAP the computing device 104 is in communication with. The list includes each SSID of a corresponding WAP the computing device 104 is connected with and the signal strength of the corresponding WAP with which the computing device 104 is connected. An example of such a list is illustrated in FIG. 3B. This list can be maintained and stored in the memory 204 of the computing device 104.

In some embodiments, the computing device 104 further includes a user interface 208. The user interface 208 can include one or more screens, displays, or monitors. For example, the computing device 104 can be a mobile device and the user interface 208 can include a touchscreen like many mobile devices have. The touchscreen can include one or more digital buttons for activating one or more applications or checking one or more settings of the computing device 104. The user interface 208 can further include one or more buttons, switches, a mouse, keyboard, stylus, or any other means of providing input into the computing device 104.

In some embodiments, the computing device 104 can maintain a map or schematic of the area 114 and the map or schematic of the area 114 can be displayed on the user interface 208 for a user of the computing device 104 to observe and interact with.

In some embodiments, the location server 108 can include any suitable server, computing device, personal computer (PC), cloud server, or any other suitable device capable of performing the tasks described herein. The location server 108 includes a processing circuit 210, which can include any of the devices described above with respect to processing circuit 202. Similarly, the location server 108 includes a memory 212, which can comprise any of the devices described above with respect to memory 204.

The location server 108 can further store data, such as location data received from the computing device 104 in a data store 116. The data store 116 can include a hard drive, solid state drive, another server, storage area network (SAN) device, database, or any other suitable data store 116. The location server 108 can receive location data from the computing device 104 and store the data in the data store 116 and periodically update the data store 116 with new location data or update the data store 116 upon new location data being received. In some examples, the data store 116 can include location and other data stored in a database for a plurality of different computing devices 104 located within the area 114.

FIG. 3A illustrates one example scenario 300 similar to the emergency situations in an area 114 as described above. For example, as a hypothetical, the scenario 300 shown in FIG. 3A illustrates the area 114 during an emergency situation whereby a fire is in a building and the area 114 is part of the building. A person, referred to as a user 302, is in the area 114 and has a computing device 104, such as a mobile device and has in their possession a contactless card 102 (not shown) capable of performing communications described herein.

The area 114 includes one or more WAPs, such as WAP 1 304, WAP 2 306, and WAP 3 310. WAP 1 304 has a Wi-Fi connection (not shown) with the computing device 104, WAP 2 306 has a Wi-Fi connection 308 with the computing device 104, and WAP 3 310 also has a Wi-Fi connection 312 with the computing device 104. As shown by the list of WAPs 314 in FIG. 3B, at the current location of the user 302 and the computing device 104, the computing device 104 has Wi-Fi signal strengths of −35.6 dBm, −50.2 dBm, and −65.3 dBm with the WAP 1 304, WAP 2 306, and WAP 3 310, respectively.

In this hypothetical, emergency response personnel may need to determine the location of the user 302. For example, the user 302 could be a firefighter that is making their way through the burning building to save other people. Alternatively, the user 302 could be an occupant of the area 114 attempting to flee the fire and reach, for example, a stairwell or emergency exit. It might be helpful to direct the person to the nearest stairwell or emergency exit, so determining the user's 302 location would be helpful.

In some embodiments, the location server 108 is configured to send, to the computing device 104, a request to identify a location of the computing device 104 within the area 114. In some embodiments, the request is configured to cause a prompt to be displayed on the user interface 208 of the computing device 104 to tap a contactless card 102 associated with a user 302 to the computing device 104. In some embodiments, the contactless card 102 is to send encrypted data to the computing device 104 during the tap. For example, the request sent by the location server 108 can be sent to an application operating on the computing device 104 and the application can display on the user interface 208 the prompt to tap the contactless card 102 to the computing device 104. When the user 302 taps the contactless card 102 to the computing device 104, the encrypted data is sent from the contactless card 102 to the computing device 104 via NFC, Wi-Fi, or other suitable wireless communication protocol described above.

After receiving the request, the computing device 104 is further configured to gather location data of the computing device 104 from one or more electrical components 110 in proximity of the computing device 104. For example, the location data can include a list of one or more SSIDs, each SSID associated with a corresponding WAP, that the computing device 104 is connectable with at a time the contactless card 102 is tapped to the computing device 104. In some embodiments, the location data further includes a Wi-Fi signal strength of each SSID in the list, the Wi-Fi signal strength gathered from Wi-Fi settings or a Wi-Fi antenna system on the computing device 104. For example, the list can include the list of WAPs 314 shown in FIG. 3B.

In some embodiments, as the user 302 moves about the area 114, the Wi-Fi signal strength for each of the WAPs depicted in FIG. 3A may change. As such, in some embodiments, the computing device 104 is configured to periodically update the list and send the updated list to location server 108. For example, during the update, the list of one or more SSIDs and corresponding Wi-Fi signal strengths for each SSID is dynamically updated to indicate available SSIDs and Wi-Fi signal strengths as the computing device 104 moves within the area 114. In some embodiments, the list of SSIDs and corresponding signal strengths is sent only once when the contactless card 102 is tapped to the computing device 104. In other embodiments, the list is sent periodically to the location server 108 so that the location of the user 302 can be determined and updated in real-time.

In some embodiments, the encrypted data from the contactless card 102 is sent by the computing device 104 to the authentication server 112 described above in FIG. 1 to verify the encrypted data and therefore determine and verify the identity of the user 302. The location data (e.g., the list of SSIDs with corresponding Wi-Fi signal strength or other location data described herein) is sent to the location server 108 to determine the location within the area 114 of the computing device 104 and thereby the user 302.

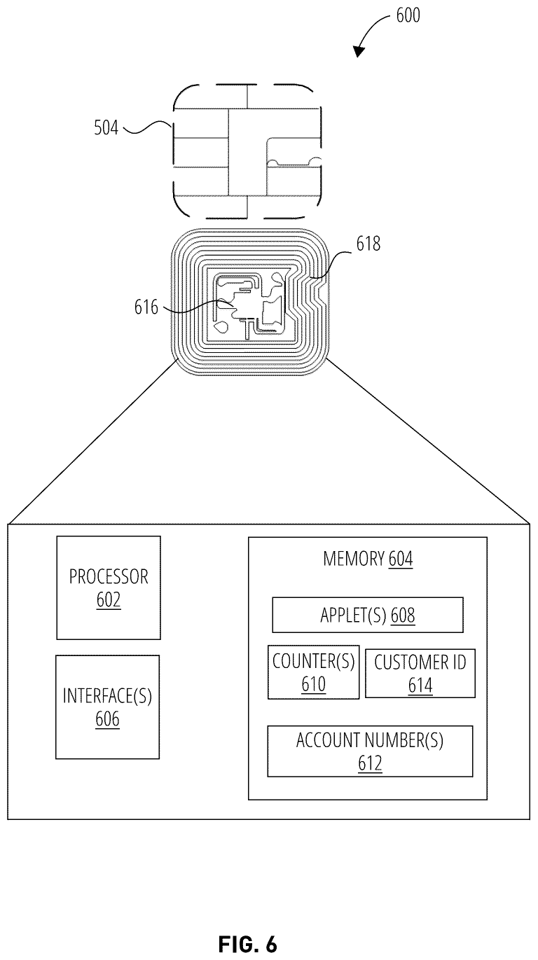

In some embodiments, the encrypted data includes an identity token referred to as a customer identifier 614 or pUID 1310 described in FIG. 6 or FIG. 13, respectively below. The identity token is unique to the contactless card 102 and is decrypted by the authentication server 112 to verify the identity of the user 302 of the contactless card 102 and the computing device 104.

In some embodiments, the location server 108 is configured to receive the location information or data from the computing device 104 and communicate with the authentication server 112 that the encrypted data is authenticated. Once the location data of the computing device 104 is received, the location server 108 is configured to determine, based on the location data, the location of the computing device 104 and therefore the user 302 within the area 114. For example, in the event that the location data is the list of SSIDs with the Wi-Fi signal strength of each SSID, the location server 108 is configured to access a Wi-Fi range map (e.g., stored in the data store 116) for the area 114 that includes each of the WAPs in the area 114. In some embodiments, the Wi-Fi range map includes estimated signal strength for each WAP at different locations in the area 114. Furthermore, the location server 108 is configured to determine the location of the mobile device based on the list of one or more SSIDs and corresponding Wi-Fi signal strengths received from the mobile device and based on the Wi-Fi range map of the area.

In some embodiments, as described above, the computing device 104 will periodically update the list of SSIDs and corresponding Wi-Fi signal strengths and send multiple lists to the location server 108. The location server 108 will then receive a plurality of lists with dynamically updated SSIDs and corresponding Wi-Fi signal strengths for available WAPs as the computing device 104 moves. The location server 108 is then configured to determine a movement of the computing device 104 based on the plurality of lists and the dynamically updated SSIDs and corresponding Wi-Fi signal strengths.

Once the location of the computing device 104 and the user 302 is determined, the location server 108 is configured to store the location in the data store 116. This may include updating a database entry in the data store 116, the database entry corresponding to the identity token associated with the contactless card 102 (e.g., the customer identifier 614 or pUID 1310 received in the encrypted data from the contactless card 102). In some embodiments, the data store 116 includes a database with a plurality of current locations stored therein, each of the plurality of current locations corresponding to a different identity token associated with a different person other than the user 302. That is, there may a plurality of users in the area 114 and the data store 116 includes a database with locations for each of the users or each of their mobile devices or computing devices.

In some embodiments, the location server 108 is further configured to display a digital map of the authentication server 112 and further configured to display an indicator at the location of the computing device 104 on the digital map. The digital map can be displayed on a display associated with the location server 108 or it can be displayed on the user interface 208 of the computing device 104. That is, the location server 108 can send a message to the computing device 104 including data sufficient for the computing device 104 to display the digital map and the indicator for the location of the user 302.

FIG. 3B illustrates an example list of WAPs 314 according to some embodiments of the present disclosure. The computing device 104 may maintain a list of WAPs 314 and their corresponding Wi-Fi signal strengths determined by the Wi-Fi settings or Wi-Fi radio of the computing device 104. In FIG. 3A, three different WAPs are shown, including WAP 1 304, WAP 2 306, and WAP 3 310. Each WAP is located a certain distance away from the computing device 104, with WAP 1 304 being the closest to the computing device 104 and WAP 3 310 being the furthest.

List of WAPs 314 includes each of the three WAPs and their respective signal strengths from FIG. 3A. For example WAP_1 of the list of WAPs 314 corresponds to the signal strength and SSID of WAP 1 304 shown in FIG. 3A. WAP_2 and WAP_3 of the list of WAPs 314 correspond to WAP 2 306 and WAP 3 310, respectively. The Wi-Fi signal strength at the computing device 104 for WAP 1 304 is −35.6 dBm, for WAP 2 306 is −50.2 dBm, and for WAP 3 310 is −65.3 dBm.

As described above, the location server 108 is configured to access a Wi-Fi signal strength map that includes Wi-Fi signal strengths for all of the WAPs in the area 114. The location server 108 is configured to determine, based on the Wi-Fi signal strength map, what location within the area 114 the computing device 104 is located at based on the signals strengths presented in the list of WAPs 314.

FIG. 3C illustrates the area 114 with the user 302, but instead of the one or more electrical components 110 being WAPs, they can include a plurality of RFID or NFC readers. For example, as shown in FIG. 3C, the area 114 can include a first RFID/NFC reader 322 and a second RFID/NFC reader 324 and these readers can be located on a wall, or next to a door or some other suitable location within the area 114. The user 302 can walk up to the first RFID/NFC reader 322 and scan their computing device 104 to gather their first location data and then scan their computing device 104 again at the second RFID/NFC reader 324. In such embodiments, the first RFID/NFC reader 322 and second RFID/NFC reader 324, when scanned by the computing device 104, will transmit their location data to the computing device 104 and the computing device 104 will then forward that data to the location server 108 for processing.

In some embodiments, each of the RFID/NFC readers will have a unique identifier associated therewith and this identifier can be stored along with the location of the corresponding RFID/NFC reader in a database in the data store 116. For example, first RFID/NFC reader 322 can have a unique identifier of “ABCD123” and the entry in the database for that identifier indicates that the first RFID/NFC reader 322 is located at “Room 201” of the area 114. The second RFID/NFC reader 324 can include a unique identifier of “ABCD124” and the database entry for the second RFID/NFC reader 324 can indicate that it is located at “Elevator 1, Second Floor.” “Room 201” and “Elevator 1” can both have location data associated therewith to indicate where those locations are with respect to other objects in the area 114. The location of each RFID/NFC reader is determined by the location server 108 based on the description in the database entry and that data can be stored in the data store 116 to indicate the location of the user 302 based on the most recent RFID/NFC reader scanned by the user 302.

The computing device 104 can scan the RFID/NFC reader after the contactless card 102 is tapped to the computing device 104. In some embodiments, the computing device 104 can prompt the user to tap the contactless card 102 each time before the RFID/NFC reader is scanned, or the computing device 104 can be configured such that the contactless card 102 is tapped once and then a scanning session on the computing device 104 is started, whereby the computing device 104 can scan multiple RFID/NFC readers during the session to show the movement of the computing device 104 and thereby the user 302.

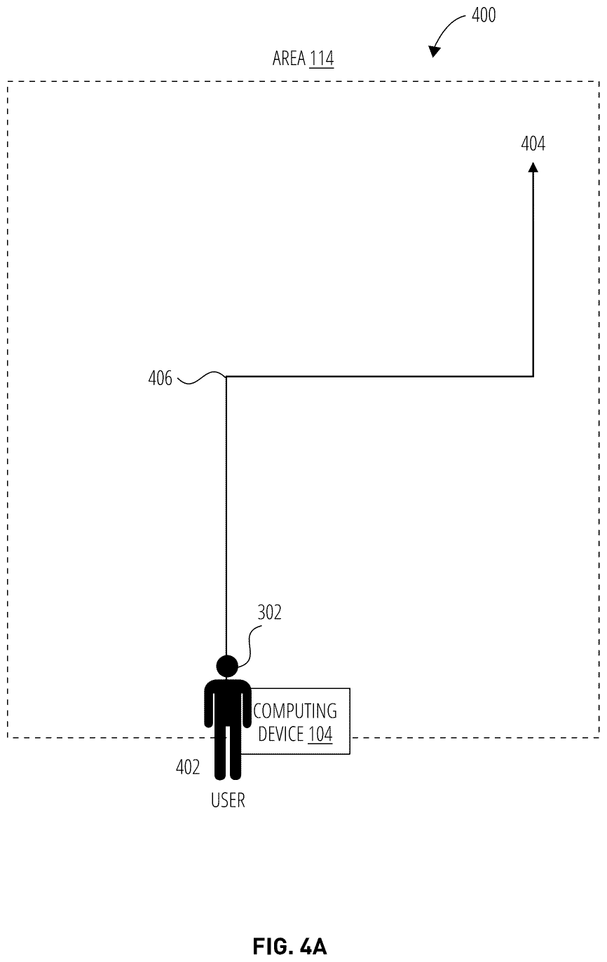

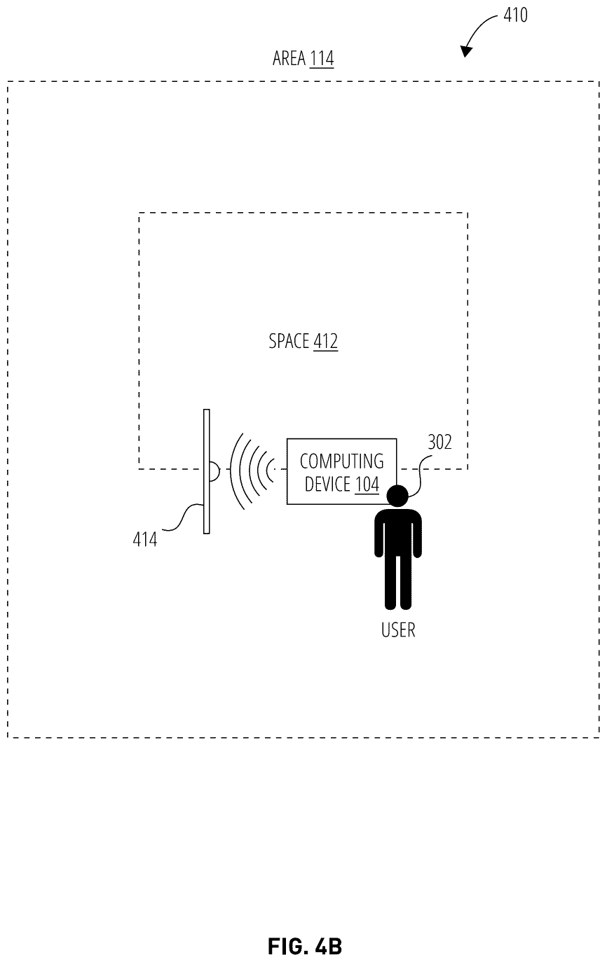

FIG. 4A illustrates another location determination scenario 400, wherein the user 302 is attempting to traverse the area 114 (e.g., of a building) to travel from the current location 402 of the user 302 to a second location 404 (e.g., the stairs to reach safety, a safe room, an emergency exit, or the like). Once the location server 108 determines the location of the user 302 as described above, the location server 108 can send various data or instructions to the computing device 104 to help the user 302 get to safety if needed.

For example, once the location server 108 determines that the user 302 is at the current location 402, the location server 108 can send instructions on how to navigate within the area 114 from the current location 402 to the second location 404. These instructions can include written instructions telling the user to travel down a hallway, go through a door, look for signs or landmarks in the area 114, etc. The instructions can also include a map of the area 114 and include a digital pathway 406 from the current location 402 to the second location 404. The computing device 104, upon receiving the instructions from the location server 108 on how to navigate within the area 114 from the current location 402 to the second location 404, can then display on the user interface 208, the instructions or a graphic representation of the instructions, such as the map of the area 114 that includes the pathway 406, for the user 302 to navigate within the area 114.

The instructions may also be written instructions and those written instructions can also be displayed on the user interface 208 for the user 302 to read.

FIG. 4B illustrates another location determination scenario 410, wherein the user 302 is attempting to enter a space 412 within the area 114, such as a safe room or a locked stairway. Once the location server 108 has determined the location of the computing device 104, and determined that the computing device 104 is near the space 412, the location server 108 can send an access code to the computing device 104 to enter the space 412. That is, the computing device 104 receives an access code from the location server 108 based on the determined location of the computing device 104. The access code can be used to access the space 412 within the area 114.

Once the access code is sent to the computing device 104, the user can then tap their computing device 104 to a door controller 414 of a security door to thereby allow access to the space 412 within the area 114. For example, the door to the space 412 can be locked and beside the door is an RFID or NFC reader. The RFID or NFC reader communicates with the door controller 414 to alter a locked state of the door or otherwise controls whether the door opens. Once the access code is received by the computing device 104 from the location server 108, the user 302 can scan their computing device 104 at the RFID or NFC reader which then reads the access code from the computing device 104. If the access code is correct for the space 412, then the door controller 414 will activate and thereby control the door to the space 412 to open and allow the user 302 to enter.

In some other example scenarios, a person is located within the space 412 and another person is located outside the space 412 and is attempting to gain entry. In an active shooter situation, it may be impossible for the person inside the space 412 to determine if the person attempting to gain entry is a safe person to let in. One way to accomplish this would be for the location server 108 to verify that the person outside the space 412 is who they say they are. The location server 108 can do this by cross referencing the identity of the person outside the space 412 by looking at the identity token of the user outside the space 412 from their contactless card 102. If the person outside the space 412 has an identity token that is validated and the location server 108 determines that their location is outside the space 412, it is likely okay for the person inside the space 412 to allow the person outside the space 412 to enter. In such an embodiment, the person inside the space 412 can send the person outside the space the access code for entry.

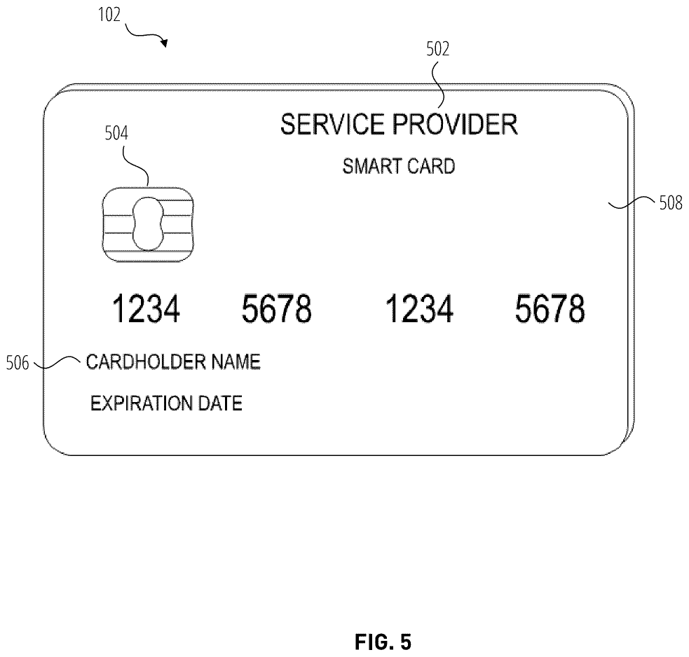

FIG. 5 illustrates an example configuration of a contactless card 102, which may include a contactless card, a payment card, such as a credit card, debit card, or gift card, issued by a service provider as displayed as service provider indicia 502 on the front or back of the contactless card 102. In some examples, the contactless card 102 is not related to a payment card, and may include, without limitation, an identification card. In some examples, the transaction card may include a dual interface contactless payment card, a rewards card, and so forth. The contactless card 102 may include a substrate 508, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 102 may have physical characteristics compliant with the ID-1 format of the ISO/IEC 7816 standard, and the transaction card may otherwise be compliant with the ISO/IEC 14443 standard. However, it is understood that the contactless card 102 according to the present disclosure may have different characteristics, and the present disclosure does not require a transaction card to be implemented in a payment card.

The contactless card 102 may also include identification information 506 displayed on the front and/or back of the card, and a contact pad 504. The contact pad 504 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 102 may also include processing circuitry, antenna and other components as will be further discussed in FIG. 6. These components may be located behind the contact pad 504 or elsewhere on the substrate 508, e.g. within a different layer of the substrate 508, and may electrically and physically coupled with the contact pad 504. The contactless card 102 may also include a magnetic strip or tape, which may be located on the back of the card (not shown in FIG. 5). The contactless card 102 may also include a Near-Field Communication (NFC) device coupled with an antenna capable of communicating via the NFC protocol. Embodiments are not limited in this manner.

FIG. 6 illustrates a transaction card component 600 that provides additional details on the contact pad 504 from FIG. 5. As illustrated in FIG. 6, the contact pad 504 of contactless card 102 may include processing circuitry 616 for storing, processing, and communicating information, including a processor 602, a memory 604, and one or more interface(s) 606. It is understood that the processing circuitry 616 may contain additional components, including processors, memories, error and parity/CRC checkers, data encoders, anticollision algorithms, controllers, command decoders, security primitives and tamperproofing hardware, as necessary to perform the functions described herein.

The memory 604 may be a read-only memory, write-once read-multiple memory or read/write memory, e.g., RAM, ROM, and EEPROM, and the contactless card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 604 may be encrypted memory utilizing an encryption algorithm executed by the processor 602 to encrypted data.

The memory 604 may be configured to store one or more applet(s) 608, one or more counter(s) 610, a customer identifier 614, and the account number(s) 612, which may be virtual account numbers. The one or more applet(s) 608 may comprise one or more software applications configured to execute on one or more contactless cards, such as a Java® Card applet. However, it is understood that applet(s) 608 are not limited to Java Card applets, and instead may be any software application operable on contactless cards or other devices having limited memory. The one or more counter(s) 610 may comprise a numeric counter sufficient to store an integer. The customer identifier 614 may comprise a unique alphanumeric identifier assigned to a user of the contactless card 102, and the identifier may distinguish the user of the contactless card from other contactless card users. The customer identifier 614 may also be referred to as the identity token described above or the pUID 1310 described below with respect to FIG. 13. In some examples, the customer identifier 614 may identify both a customer and an account assigned to that customer and may further identify the contactless card 102 associated with the customer's account. As stated, the account number(s) 612 may include thousands of one-time use virtual account numbers associated with the contactless card 102. An applet(s) 608 of the contactless card 102 may be configured to manage the account number(s) 612 (e.g., to select an account number(s) 612, mark the selected account number(s) 612 as used, and transmit the account number(s) 612 to a mobile device or a computing device 104 for autofilling by an autofilling service.

In some embodiments, the memory 604 can include (e.g., have stored therein) the data from the fields shown in FIG. 6 and/or FIG. 13. The processor 602 can then use the data from the fields to generate the message 1300 as described above.

The processor 602 and memory elements of the foregoing exemplary embodiments are described with reference to the contact pad 504, but the present disclosure is not limited thereto. It is understood that these elements may be implemented outside of the contact pad 504 or entirely separate from it, or as further elements in addition to processor 602 and memory 604 elements located within the contact pad 504.

In some examples, the contactless card 102 may comprise one or more antenna(s) 618. The one or more antenna(s) 618 may be placed within the contactless card 102 and around the processing circuitry 616 of the contact pad 504. For example, the one or more antenna(s) 618 may be integral with the processing circuitry 616 and the one or more antenna(s) 618 may be used with an external booster coil. As another example, the one or more antenna(s) 618 may be external to the contact pad 504 and the processing circuitry 616.

In an embodiment, the coil of contactless card 102 may act as the secondary of an air core transformer. The terminal may communicate with the contactless card 102 by cutting power or amplitude modulation. The contactless card 102 may infer the data transmitted from the terminal using the gaps in the contactless card's power connection, which may be functionally maintained through one or more capacitors. The contactless card 102 may communicate back by switching a load on the contactless card's coil or load modulation. Load modulation may be detected in the terminal's coil through interference. More generally, using the antenna(s) 618, processor 602, and/or the memory 604, the contactless card 102 provides a communications interface to communicate via NFC, Bluetooth®, and/or Wi-Fi communications.

As explained above, contactless card 102 may be built on a software platform operable on smart cards or other devices having limited memory, such as JavaCard, and one or more or more applications or applets may be securely executed. Applet(s) 608 may be added to contactless cards to provide a one-time password (OTP) for multifactor authentication (MFA) in various mobile application-based use cases. Applet(s) 608 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 608 may be configured to encode the OTP as an NDEF type 4 well known type text tag. In some examples, NDEF messages may comprise one or more records. The applet(s) 608 may be configured to add one or more static tag records in addition to the OTP record.

In some examples, the one or more applet(s) 608 may be configured to emulate an RFID tag. The RFID tag may include one or more polymorphic tags. In some examples, each time the tag is read, different cryptographic data is presented that may indicate the authenticity of the contactless card. Based on the one or more applet(s) 608, an NFC read of the tag may be processed, the data may be transmitted to a server, such as a server of a banking system, and the data may be validated at the server.

In some examples, the contactless card 102 and server may include certain data such that the card may be properly identified. The contactless card 102 may include one or more unique identifiers (not pictured). Each time a read operation takes place, the counter(s) 610 may be configured to increment. In some examples, each time data from the contactless card 102 is read (e.g., by a mobile device), the counter(s) 610 is transmitted to the server for validation and determines whether the counter(s) 610 are equal (as part of the validation) to a counter of the server.

The one or more counter(s) 610 may be configured to prevent a replay attack. For example, if a cryptogram has been obtained and replayed, that cryptogram is immediately rejected if the counter(s) 610 has been read or used or otherwise passed over. If the counter(s) 610 has not been used, it may be replayed. In some examples, the counter that is incremented on the card is different from the counter that is incremented for transactions. The contactless card 102 is unable to determine the application transaction counter(s) 610 since there is no communication between applet(s) 608 on the contactless card 102.

In some examples, the counter(s) 610 may get out of sync. In some examples, to account for accidental reads that initiate transactions, such as reading at an angle, the counter(s) 610 may increment but the application does not process the counter(s) 610. In some examples, when the computing device 104 is woken up, NFC may be enabled and the computing device 104 may be configured to read available tags, but no action is taken responsive to the reads.

To keep the counter(s) 610 in sync, an application, such as a background application, may be executed that would be configured to detect when the mobile computing device 104 wakes up and synchronize with the server of a banking system indicating that a read that occurred due to detection to then move the counter(s) 610 forward. In other examples, Hashed One Time Password may be utilized such that a window of mis-synchronization may be accepted. For example, if within a threshold of 10, the counter(s) 610 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 610 increases in the appropriate sequence, then it possible to know that the user has done so.

The key diversification technique described herein with reference to the counter(s) 610, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 102, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 102 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

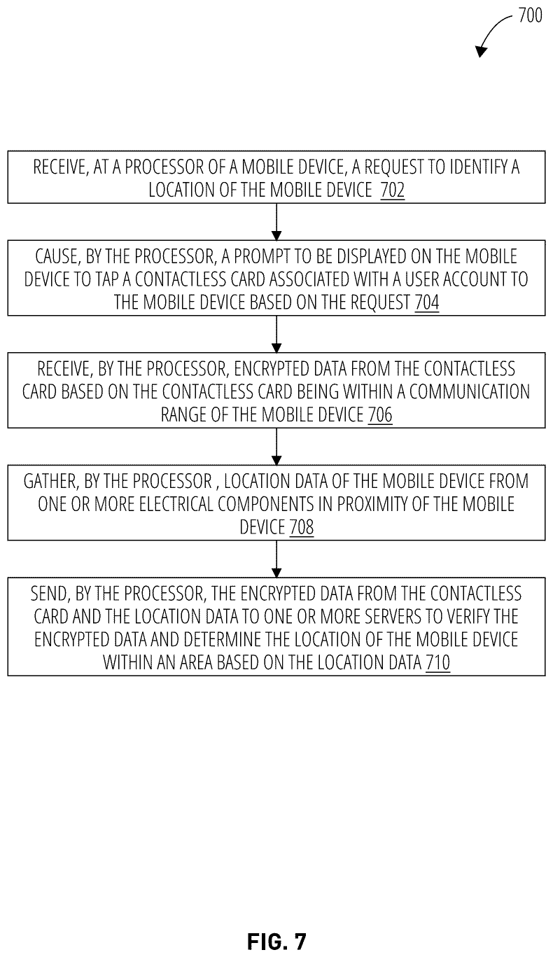

FIG. 7 is a flow chart illustrating various operations in an example method 700 for contactless card assisted location determination. In some embodiments, as shown at block 702, the method 700 includes receiving, at a processor of a mobile device, a request to identify a location of the mobile device. In some embodiments, at block 704, the method 700 includes causing, by the processor, a prompt to be displayed on the mobile device to tap a contactless card associated with a user account to the mobile device based on the request. As shown at block 706, in some embodiments, the method 700 includes receiving, by the processor, encrypted data from the contactless card based on the contactless card being within a communication range of the mobile device. As shown at block 708, in some embodiments, the method 700 includes gathering, by the processor, location data of the mobile device from one or more electrical components in proximity of the mobile device. As shown at block 708, in some embodiments, the method 700 includes sending, by the processor, the encrypted data from the contactless card and the location data to one or more servers to verify the encrypted data and determine the location of the mobile device within an area based on the location data.

In some embodiments, the one or more electrical components includes one or more wireless access points (WAPs) and the location data includes a list of one or more service set identifiers (SSIDs), each SSID associated with a corresponding WAP, that the mobile device is connectable with at a time the contactless card is tapped to the mobile device. In some embodiments, the location data further includes a wireless fidelity (Wi-Fi) signal strength of each SSID in the list, the Wi-Fi signal strength gathered from Wi-Fi settings or a Wi-Fi antenna system on the mobile device. In some embodiments, the method 700 further includes updating, by the processor, the list periodically and sending the updated list to the one or more servers, where the list of one or more SSIDs and corresponding Wi-Fi signal strengths for each SSID is dynamically updated to indicate available SSIDs and Wi-Fi signal strengths as the mobile device moves within the area.

In some embodiments, the electrical components include one or more radio frequency identification (RFID) or near-field communication (NFC) readers that provide location data of the RFID or NFC reader within the area. In some embodiments, gathering the location data includes bringing the mobile device in close proximity of the RFID or NFC reader to receive the location data thereof within the area. In some embodiments the method 700 further includes receiving, at the processor, an access code from one of the one or more servers based on the determined location of the mobile device, the access code for accessing a space within the area. In some embodiments, the method 700 further includes sending, by the processor, the access code to a controller of a door to thereby allow access to the space within the area.

In some embodiments, the encrypted data includes an identity token that is unique to the contactless card and is decrypted by the one or more servers to verify an identity of a user of the contactless card. In some embodiments, the method 700 further includes receiving, at the processor, instructions from the one or more servers on how to navigate within the area from the location of the mobile device to a second location. In some embodiments, the method 700 further includes displaying, by the processor, the instructions or a graphic representation of the instructions on a user interface of the mobile device for a user to navigate within the area.

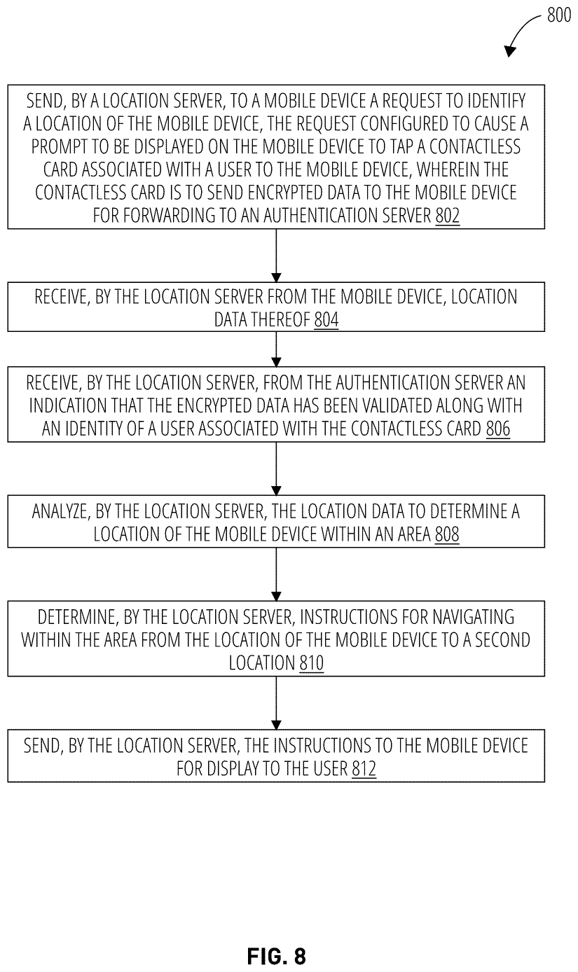

FIG. 8 is a flow chart illustrating various operations in another method for contactless card assisted location determination according to another embodiment of the present disclosure. As show at block 802, the method 800 includes sending, by a location server, to a mobile device a request to identify a location of the mobile device, the request configured to cause a prompt to be displayed on the mobile device to tap a contactless card associated with a user to the mobile device, wherein the contactless card is to send encrypted data to the mobile device for forwarding to an authentication server. As shown at block 804, the method 800 includes receiving from the mobile device location data thereof.

As shown at block 806, the method 800 includes receiving, by the location server from the authentication server, an indication that the encrypted data has been validated along with an identity of a user associated with the contactless card. As shown at block 808, the method 800 includes analyzing, by the location server, the location data to determine a location of the mobile device within an area. As shown at block 810, the method 800 includes determining, by the location server, instructions for navigating within the area from the location of the mobile device to a second location. As shown at block 812, the method 800 includes sending, by the location server, the instructions to the mobile device for display to the user.

In some embodiments, the method 800 further includes causing, by the location server, an access code to be sent to the mobile device, the access code for gaining access to the second location or another space within the area. In some embodiments, the location data includes a list of one or more service set identifiers (SSIDs), each SSID associated with a corresponding WAP, that the mobile device is connectable with at a time the contactless card is tapped to the mobile device. In some embodiments, the location data further includes a wireless fidelity (Wi-Fi) signal strength of each SSID in the list, the Wi-Fi signal strength gathered from Wi-Fi settings or a Wi-Fi antenna system on the mobile device.

In some embodiments, the method 800 further includes accessing, by the location server, a Wi-Fi range map for the area that includes each of the WAPs in the area, the Wi-Fi range map including estimated signal strength for each WAP at different locations in the area. In some embodiments, the method 800 includes determining, by the location server, the location of the mobile device based on the list of one or more SSIDs and corresponding Wi-Fi signal strengths received from the mobile device and based on the Wi-Fi range map of the area. In some embodiments, the method 800 includes storing the location of the mobile device in a data store that includes a plurality of current locations stored therein, each of the plurality of locations corresponding to the location of a different mobile device located within the area.

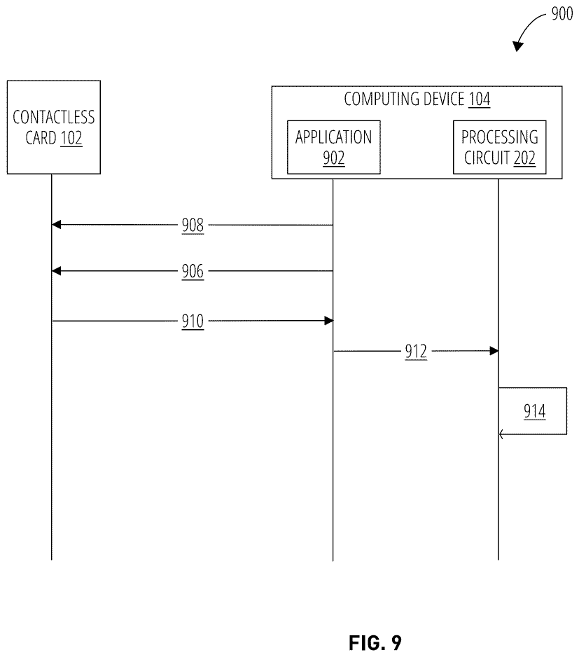

FIG. 9 is a timing diagram illustrating an example sequence for providing encrypted data from the contactless card 102 to the computing device 104. Sequence flow 900 may include contactless card 102 and computing device 104, which may include an application 902 and processing circuit 202.

At line 908, the application 902 communicates with the contactless card 102 (e.g., after being brought near the contactless card 102). Communication between the application 902 and the contactless card 102 may involve the contactless card 102 being sufficiently close to a card reader (not shown) of the computing device 104 to enable NFC data transfer between the application 902 and the contactless card 102.

At line 906, after communication has been established between computing device 104 and contactless card 102, contactless card 102 generates a message authentication code (MAC) cryptogram. In some examples, this may occur when the contactless card 102 is read by the application 902. In particular, this may occur upon a read, such as an NFC read, of a near field data exchange (NDEF) tag, which may be created in accordance with the NFC Data Exchange Format. For example, a reader application, such as application 902, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 902 may be configured to transmit a request to contactless card 102, the request comprising an instruction to generate a MAC cryptogram.

At line 910, the contactless card 102 sends the MAC cryptogram to the application 902. In some examples, the transmission of the MAC cryptogram occurs via NFC, however, the present disclosure is not limited thereto. In other examples, this communication may occur via Bluetooth®, Wi-Fi, or other means of wireless data communication. At line 912, the application 902 communicates the MAC cryptogram to the processor processing circuit 202.

At line 914, the processor processing circuit 202 verifies the MAC cryptogram pursuant to an instruction from the application 902. For example, the MAC cryptogram may be verified, as explained below. In some examples, verifying the MAC cryptogram may be performed by a device other than computing device 104, such as a server of a banking system in data communication with the computing device 104. For example, processor processing circuit 202 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

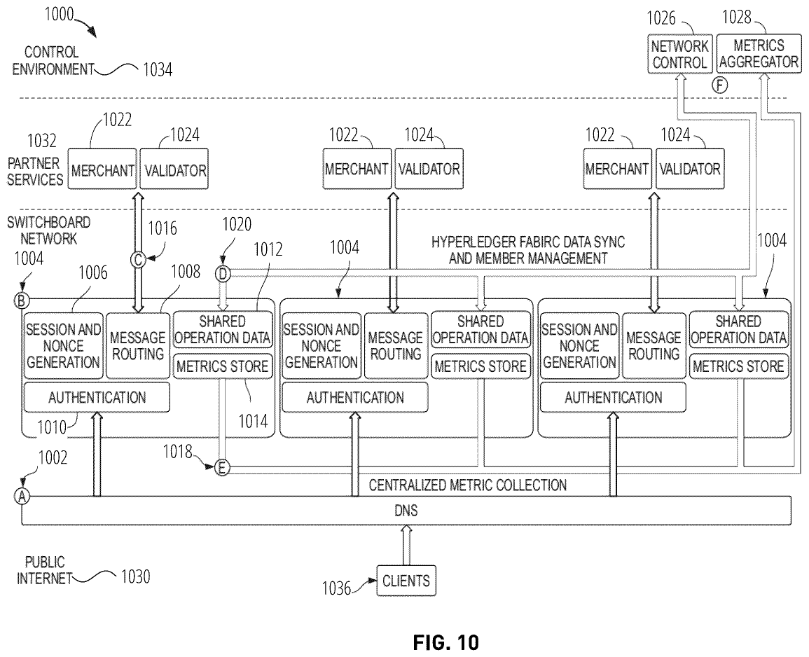

FIG. 10 illustrates an example of system 1000 in accordance with the embodiments discussed herein. The system 1000 includes additional devices and systems configured to enable contactless card issuers to tap-to-card services. Specifically, system 1000 enables any number of issuer systems to provide card services to their clients through a switching fabric, i.e., the switchboard system in a secure and safe manner. Once the encrypted data is sent from the contactless card 102 to the computing device 104 in FIG. 3A above, the computing device 104 is to send the encrypted data to the system 1000 for decrypting and validation. The authentication server 112 of FIG. 1 is equivalent to the validation system 1024 described herein. The merchant system 1022 is equivalent to the location server 108 described above.

In embodiments, the switchboard system includes one or more nodes 1004 configured to perform routing operations. Each switchboard node 1004 may include a session and nonce generator 1006, a message router 1008, an authentication 1010, an operation data 1012 store, and a metrics store 1014. Further, each of the nodes may be configured the same and share configurations, but each switchboard node 1004 may independently process and route messages and requests to the appropriate systems, such as the merchant systems and issuer systems. Each of the nodes 1004 is configured to act as a broker of trust between an issuer system, the merchant system 1022, and/or validation system 1024, for example. Each switchboard node 1004 is configured to route each message to the correct issuer system while maintaining data security.

For example, a switchboard node 1004 may route a message between an issuer system and a merchant system while the node cannot access the private data in the message.

The switchboard system 1000 may be configured as a server system with a collection of hardware, software, and networking components that work together to provide client services. Hardware components may include one or more server computers, storage devices, and network adapters. The server computers are configured to run server applications, such as those executable on each of the nodes 1004. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

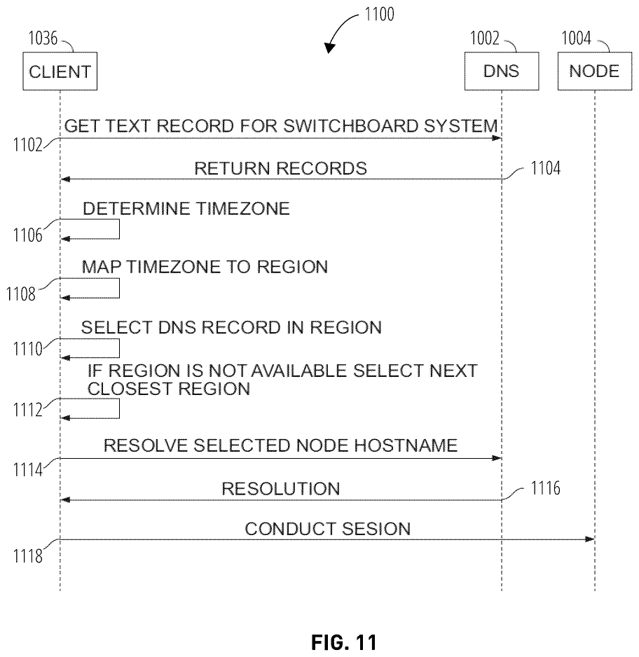

In some embodiments, the nodes 1004 may operate in a cloud-based computing environment, e.g., a collection of hardware, software, and networking components that enable the delivery of cloud computing services. The switchboard nodes 1004 and the computing services are delivered over the Internet and can be accessed from anywhere in the world with an Internet connection. In embodiments, client 1036 may access a switchboard node 1004 through DNS 1002 or Domain Name System (DNS). The DNS 1002 is a hierarchical and distributed naming system for computers, services, and other resources connected to the Internet or other networks. It associates various information with domain names assigned to each registered participant. In one example, the DNS 1002 may translate a name known to software executing on a client 1036 to route data to one or more of switchboard node 1004 of the switchboard system. In embodiments, the DNS 1002 may generate a number, such as an Internet Protocol (IP) address, an address record (A-record), or another Hostname (C-name record). FIG. 11 illustrates one example sequence 1100 for a client to identify and resolve an identifier for one of the nodes 1004 of the switchboard system. At a high level, the DNS 1002 translates known domain names to numerical Internet Protocol (IP) addresses needed for locating and identifying computer services and devices with the underlying network protocols. Clients use the global DNS system to select the best node to use, as discussed in sequence 1100.

In embodiments, a client 1036 communicates with the switchboard system to perform one or more of the partner services 1032, such as conducting a transaction with a merchant, validating the customer, or other tap-to functions. Once client 1036 identifies a switchboard node 1004 and resolves an address to communicate with switchboard node 1004, client 1036 may send one or more messages to switchboard node 1004 to authenticate and perform the operation. The switchboard node 1004 includes an authentication 1010 function that is configured to authenticate the client 1036. In embodiments, the client 1036 sends a message or authorization request to the switchboard node 1004 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where Table 1 describes the value, name, and meaning:

TABLE 1

| Value | Name | Meaning |
|---|---|---|
| 65535 | Client | Individual |
| | ID | identifier of client |
| GReyx5BuEAaE72bWbFZJfHRL8Dbt1Uum | Client | Randomly |
| | Key | assigned key |

The switchboard node 1004 may authorize or authenticate the client 1036 or user, and the switchboard node 1004 may utilize the additional components, such as the session and nonce session and node generator 1006 and message router 1008, to perform the operations. Note the validation systems validation system 1024 never interact with the merchant systems 1022, nor vice versa. The nodes node 1004 brokers all communication.

In embodiments, the switchboard system may utilize a hyper ledger fabric 1020 to manage to synchronize the shared operation data 1012 and member management across the network. The hyperledger fabric 1020 is distributed ledger framework having a permissioned network model that only authorized participants can join the network and access the data that is stored on a ledger.

In embodiments, the hyperledger fabric 1020 may be generated by creating one or more sets of peers, an ordering service, and a channel. Once the network is created, system 1000 deploys chaincode to the network, or node 1004 is permitted to access the fabric. The chaincode is the code that runs on the blockchain and executes the network control 1026 and operation data 1012 logic code. Once the chaincode is deployed, each of the switchboard nodes 1004 is configured to invoke transactions on the blockchain to add data to the blockchain, e.g., the operational data. A switchboard node 1004 or another device can query the ledger to retrieve data. The ledger is a distributed database that stores all the data added to the blockchain.

All nodes 1004 keep an independently verifiable log of their actions that can be transmitted to a centralized aggregator to build a picture of overall network usage. System 1000 can manage network operation data and management at a central level and have a centralized view of network use, aggregated and abstracted to the appropriate level.

FIG. 11 illustrates an example sequence 1100 for a client to utilize DNS to resolve and communicate with one or more nodes of a switchboard system. The illustrated sequence 1100 includes a client 1036, a DNS 1002, and a switchboard node 1004. At 1102, the sequence 1102 includes the client 1036 sending a request to a default DNS server for a text record switchboard. {domain}. {tld}. The text record may be preconfigured in a client app and/or client SDK. At 1104, the DNS 1002 returns one or more records. A DNS record structure may include the following:
Root Record:
   Name: switchboard.{domain}.{tld}
   Type: TXT
   Resolution:
      {nodename_1}.{operator_a}.{region_i}.switchboard.{domain}.{tld},
      {nodename_2}.{operator_a}.{region_i}.switchboard.{domain}.{tld},
      {nodename_1}.{operator_b}.{region_ii}.switchboard.{domain}.{tld},
      {nodename_2}.{operator_b}.{region_ii.switchboard.{domain1.{tld},
      etc.
   Used For determining where there are active nodes
Node Record:
   Name: {nodename}.{operator1.{region}.switchboard.{domain}.{tld}
   Type: A/AAAA or CNAME
   Resolution: Actual node hostname or IP
   Used For: communicating with a node 1004

In embodiments, the client 1036 may determine the current timezone at 1106. For example, the client app or SDK may utilize a get current timezone function, such as in JavaScript: Intl.DateTimeFormatO.resolvedOptions( ).timeZone). Embodiments are not limited in this manner, and the app or sdk may determine the timezone via another/different function call. At 1108, the client 1036 is configured to map the timezone to a region or short-version identifier of the region. One example includes America/New_York->na-e. The region may be based on DNS names, for example. Table 2 illustrates a few examples of timezone mappings to regions:

TABLE 2

| Timezone | Region | Short Version |
|---|---|---|
| America/New_York | North America/East | na-e |
| America/Buenos_Aires | South America | sa |
| US/Pacific | North America/West | na-w |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e<->na-w and sa<->na-w and sa<->na-e. This representation is useful for node selection.

At 1110, the client 1036 may identify or select a DNS record option returned at 1104 that is in the region. If there are multiple matches, the client 1036 may select one at random. If there's no node available in a region, the client 1036 may determine and use a data graph of neighboring regions to select a node in the closest region where a node is available at 1112. For example, sa has no node but is connected to na-e where there is a node and so na-e is selected. In some embodiments,

At 1114, the client may resolve a selected node's hostname. In embodiments, the client 1036 may automatically resolve the hostname using the client's HTTP request default resolver. At 1116, the DNS 1002 may return a result. And at 1118, the client 1036 may communicate with a switchboard node 1004 and begin the process to interact with the switchboard.

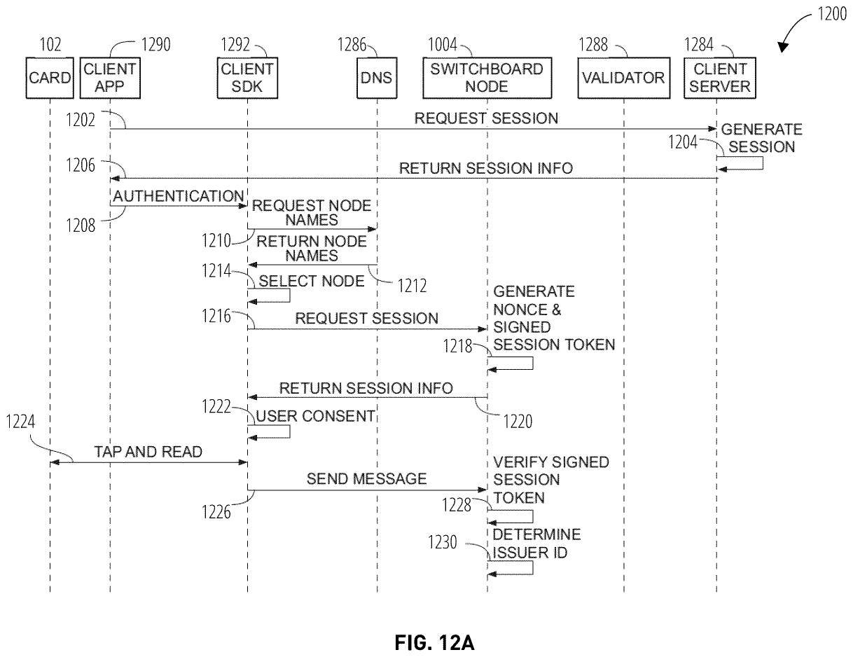

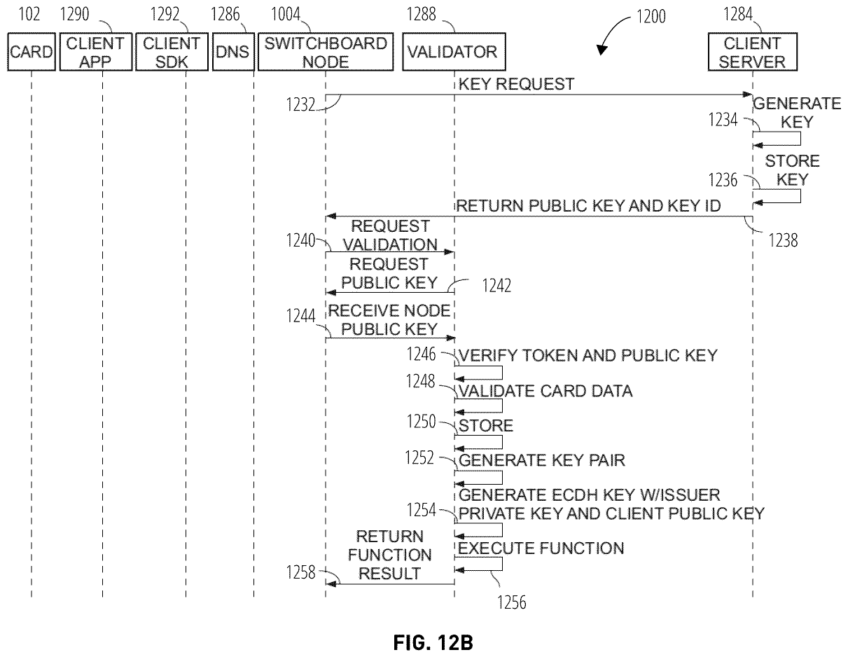

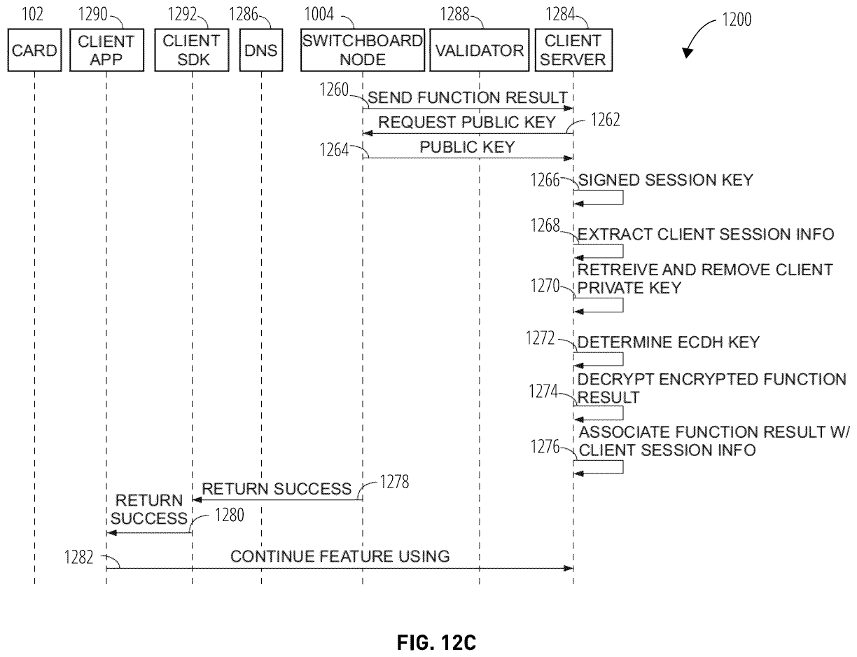

FIG. 12A-FIG. 12C illustrate an example sequence 1200 to perform operations between a contactless card 102 and services provided by a card issuer and/or merchant. The illustrated sequence 1200 includes actions and communications performed by a contactless card 102, a client 1036 including a client app 1290 and a client SDK 1292, a DNS 1286, a switchboard system including one or more nodes 1004, a partner services 1032 including a merchant and/or validator 1288, and control services 1034 including a client server 1284 or system. In embodiments, the client app 1290 may be any application configured to execute on a client 1036, such as a banking app, a merchant app, a social media app, a travel app, a gaming app, a productivity app, an entertainment app, and so forth. In embodiments, the client app 1290 includes a web browser to provide websites and pages. The client app 1290 may include and/or utilize the client SDK 1292, which may be a set of instructions that enable the client app 1290 to communicate with other components of the switchboard system.

In embodiments, as shown in FIG. 12A, at 1202 the client 1036 including the client app may send a request and establish a session with a client server 1284 such that a result may be associated with the correct client device or user. The request establishes a relationship between the client device and client server, which may be an issuer server. At 1204, the client server 1284 generates a session and CLIENT SESSION INFORMATION. At 1206, the client server 1284 returns the session information, e.g., the CLIENT SESSION INFORMATION. In embodiments, the CLIENT SESSION INFORMATION may be the Client implementation-specific user session identification information.

At 1208, the client 1036 may initiate a contactless card authentication process with the client 1036. For example, the client 1036 may call a function and/or pass information to the client 1036 to initiate authentication via a contactless card 102. At 1210-1214, the client 1036 may utilize DNS to identify a node and establish communication with the node. Specifically, at 1210, the client 1036 including the client SDK 1292 may send a request for switchboard hostnames, and at 1212 the the DNS 1286 may return information including one or more hostnames. At 1214, the client 1036 may determine a switchboard node to communicate. FIG. 11 illustrates an example of a more detailed sequence of the process to establish communication with a switchboard node 1004.

At 1216, the client 1036 may send a request for a session to the switchboard system 1000. In embodiments, the request for a session may be for a function request in the format <FUNCTION REQUEST>. In embodiments, the FUNCTION REQUEST may be the data/function that the client 1036 would like to request once a contactless card 102 has been validated. The function could be for any service discussed herein, e.g., authenticate the user, perform a transaction, request autofill data, etc. At 1218, switchboard system 1000 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card 102. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>,<CLIENT SESSION INFO>, and <FUNCTION REQUEST>signed with <NODE PRIVATE KEY>, where the NODE PRIVATE KEY is the switchboard system 1000 private key. The switchboard system 1000 may include a NODE PUBLIC/PRIVATE KEY, which is a keypair used to sign and validate JWTs.

At 1220, the switchboard system 1000 may return session information to the client 1036. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 1222, the client SDK 1292 may determine and/or receive user consent to the terms of service. In one example, the client SDK 1292 captures and records the user consent to <FUNCTION TOS> on <CONSENT DATE> with <TOS VERSION>. The CONSENT DATE may be the timestamp for the user's consent to the TOS.

At 1224, the client 1036 exchanges one or more messages with a contactless card. In one example, the exchange may be based on the contactless card being tapped to a client device. In embodiments, the client SDK 1292 may provide data to the contactless card 102 to use during the session to perform the function. The data may be provided to the contactless card 102 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

TABLE 3

| Byte | Data Item | Value |
|---|---|---|
| 00 | NDEF Message | D1 (only record) |
| | Tag | |
| 01 | Length of Record | 01 |
| | Type | |
| 02 | Length of Record | 33 |
| 03 | text record type | 54 |
| 04 | Length of | 02 |
| | Language | |
| 05-06 | Language | 65 6E (“en”) |
| 07 . . . 0E | NONCE | 8 bytes of ASCII HEX |
| | | encoded 4 bytes |
| | | binary data |
| 0F . . . 12 | Session | 4 bytes of ASCII |
| | Indicators | HEX encoded 2 bytes |
| | | binary data |
| 13 . . . 16 | Control | 4 bytes of ASCII |
| | Indicators | HEX encoded 2 bytes |
| | | binary data |
| 17 . . . 26 | Update | 16 bytes of ASCII |
| | Date | HEX encoded 8 bytes |
| | creation Time | binary data - represents |
| | | 64 bit unix timestamp |
| 27 . . . 36 | Update MAC | MAC to protect control |
| | | indicators - 16 bytes |
| | | of ASCII HEX encoded |
| | | 8 bytes binary data |

The updated MAC may be calculated to protect the control indicators in embodiments. Specifically, The MAC M is determined by calculating a MAC over the 10 bytes of the update data U with the Update MAC Card Key (MCK), as described in FIG. 13, message 1300.

At 1224, the contactless card may generate and provide a message to the client's device including the client SDK 1292. The data in the message may be utilized by the system discussed herein to perform the function requested. One example of the message is illustrated and discussed in FIG. 13, message 1300.

At 1226, the client including the client SDK 1292 may send a message and information to the switchboard system 1000. The message may be the message received from the contactless card 102, e.g., message 1300. In addition, the client SDK 1292 may send the consent date, the TOS version, and the signed session token to the switchboard system 1000. The switchboard system 1000 may utilize the information to ensure the session is valid. At 1228, the switchboard system 1000 verifies the signed session token is valid, e.g., is the previously provided signed session token and includes the nonce previously generated and is in the message.

In some embodiments, the switchboard system 1000 is configured to determine which issuer system or client-server it should route the message to for processing. At 1230, the switchboard system 1000 may determine the issuer ID by extracting it from the message received from the contactless card 102 via the client SDK 1292. As mentioned, the issuer ID identifies the issuer of the contactless card 102.

FIG. 12B continues the sequence 1200 from FIG. 12A. In embodiments, the switchboard system 1000 is configured to generate and communicate secure communications with the issuer system, e.g., the client server 1284 and the validator 1288. At 1232, the switchboard system 1000 sends a request for a key to the client server 1284. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 1234, the client server 1284 generates a portion of the key. In some instances, the client server 1284 may generate half of the ECDH key for encryption/decryption of PII. Specifically, the client server 1284 may generate <CLIENT EC PUBLIC KEY> and <CLIENT EC PRIVATE KEY> using Elliptic Curve P256. The CLIENT EC PUBLIC KEY AND CLIENT EC PRIVATE KEY is the first half of the ECDH key negotiation.

At 1236, the client-server 1284 stores the generated portion of the key in storage. Specifically, the client server 1284 may store <CLIENT EC PUBLIC KEY> and <CLIENT EC PRIVATE KEY> with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 1284 may return the public key portion to the switchboard system 1000 with the KEY ID at 1238. The switchboard system 1000 may store the public key portion with the KEY ID for later use, e.g., generation of the ECDH key. At 1240, the switchboard system 1000 may request a validation to be performed by the validator 1288. In one example, the switchboard system 1000 may send a request validation as Request validation <MESSAGE>, <SIGNED SESSION TOKEN>, <CLIENT EC PUBLIC KEY>, <CONSENT DATE>, and the <TOS VERSION>. The validator 1288 may make an out-of-band request back to the switchboard system 1000 for the public key to verify the session at 1242. At 1244, the switchboard system 1000 may provide the node's public key, i.e., <NODE PUBLIC KEY>. Further at 1246, the validator 1288 may utilize the node's public key to verify the secure session token.

In embodiments, the validator 1288 may validate the message at 1248. In embodiments, the validator 1288 may perform a number of validations including ensuring the nonce in the message is correct along with additional information, such as the card's unique identifier (pUID), and the counter value (pATC).

At 1250, the validator 1288 may store information associated with the session. For example, validator 1288 may store the <CONSENT DATE> with the <TOS VERSION> and the <PUID>. The validator 1288 may also generate another portion of the key, e.g., the ECDH key. For example, the 1288 may Generate <ISSUER EC PUBLIC KEY> and <ISSUER EC PRIVATE KEY>using Elliptic Curve P256. The ISSUER EC PUBLIC KEY and ISSUER EC PRIVATE KEY may be the second half of the ECDH key negotiation.

At 1254, the validator 1288 may generate the complete ECDH key. For example, the validator 1288 generates the <ECDH KEY>from <ISSUER EC PRIVATE KEY> and <CLIENT EC PUBLIC KEY>. The ECDH KEY is the final key generated using ECDH key negotiation.

The validator 1288 may utilize the ECDH KEY to encrypt data for the function. For example, if the validator 1288 validates the message in some instances, the validator 1288 may execute a function request to create a function result and encrypt the result with the ECDH KEY at 1256. For example, the validator 1288 may Execute <FUNCTION REQUEST> to create <FUNCTION RESULT> and encrypt it with the <ECDH KEY>. The function result may be any result based on the requested function, e.g., verification of the card.

At 1258, the validator 1288 may return the function result to the switchboard system 1000. In some instances, the function result is returned encrypted. For example, the validator 1288 may return the <ENCRYPTED FUNCTION RESULT> and the <ISSUER EC PUBLIC KEY>.

FIG. 12C continues the sequence 1200 from FIG. 12B. In embodiments, at 1260 the switchboard system 1000 sends the function result to the client server 1284 to process the result. In one example, the switchboard system 1000 may send the <ENCRYPTED FUNCTION RESULT>, <KEY ID>, <ISSUER EC PUBLIC KEY>, and <SIGNED SESSION TOKEN>. At 1262 and 1264, the client server 1284 may make a request for and receive the public key from the switchboard system 1000. In some instances, the exchange may be performed via out-of-band communication channels. The public key for the node may be <NODE PUBLIC KEY>. The public key may be used to verify the sender of the function result, etc. At 1266, the client server 1284 may verify the signed session key with the node's public key <NODE PUBLIC KEY> to verify the sender of the information. At 1268, the client server 1284 may extract client information from the signed session token. For example, the client server 1284 may Extract <CLIENT SESSION INFO>from <SIGNED SESSION TOKEN>, i.e., extracting the client implementation-specific user session identification information.

Further, at 1270, the client server 1284 may retrieve the client's private key with the KEY ID. Specifically, the client server 1284 may get and remove the <CLIENT PRIVATE KEY>from cache using the <KEY ID>. At 1272, the client server 1284 may generate or compute the ECDH key. For example, the client server 1284 may compute the <ECDH KEY> with the <CLIENT PRIVATE KEY>+<ISSUER EC PUBLIC KEY>. The client server 1284 may decrypt the function result with the computed key at 1274. Specifically, the client server 1284 may decrypt the <ENCRYPTED FUNCTION RESULT> with the <ECDH KEY> to determine the <FUNCTION RESULT>. At 1276, the client server 1284 associates the function result with the session.

In embodiments, the switchboard system 1008 may return whether the function result was successfully completed or not at 1278 to the client SDK 1292. Further at 1280, the client SDK 1292 may notify the client app 1290 of the result. At 1282, the client app 1290 may utilize the feature. For example, the 1282 may communicate with the client server 1284 to continue the feature using the <CLIENT SESSION INFO> to fetch the redacted <FUNCTION RESULT>.

FIG. 13 illustrates an example of a message 1300 that may be communicated by the contactless card 102 to the computing device 104 to send encrypted data thereto and to perform the functions described herein, such as those discussed in FIG. 12A through FIG. 12C. One or more of the fields in message 1300 may also be utilized to route the message 1300 through the switchboard system and perform authentication/validation techniques.

In embodiments, the message 1300 includes an applet version 1302 field, an issuer discretionary indicator 1304 field, an Issuer Identifier 1306 field, a pKey ID 1308 field, a pUID 1310 field, a pATC 1312 field, a nonce 1314 field, and an encrypted cryptogram 1316.

In embodiments, the fields may be in plain text or encrypted. For example, the applet version 1302 field may include an applet version in plain text. The applet version indicates which applet version is installed on a contactless card and may be used by the other systems to determine how to process the message 1300 when communicated. For example, different Applet versions require different validation logic, e.g., an older message may be routed through the issuer system to perform various operations for validation, while a newer message may be routed through the switchboard system to perform the various operations, including validation.

In embodiments, the message 1300 includes an issuer discretionary indicator 1304 field that may include issuer data and set at the time of personalization. In addition, the message 1300 includes an Issuer Identifier 1306 field that may include a unique ID assigned to the entity issuing the card, e.g., the issuer. For example, when joining the system, each issuer may be assigned a unique identifier during an onboarding operation. The issuer ID can be used by the switchboard system 1008 to route a message and its contents to the appropriate services that are associated with that particular issuer.

In embodiments, the message 1300 includes a pKey ID 1308 field. In some instances, the pKey ID 1308 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each contactless card 102 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described herein.

The message 1300 may include a pUID 1310 field, including a card unique identifier assigned to the contactless card at personalization time. The pUID 1310 field data may be a combination of alphanumeric characters used to identify each card and associated with a user uniquely.

In embodiments, the message 1300 includes a pATC 1312 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 1300 is created, a new session key is derived and utilized to generate one or more portions of the message 1300. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1300 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the contactless card 102 may communicate a message between a device, such as a mobile device, during a read operation. For example, when the contactless card 102 is brought within wireless communication range of the mobile device, a read operation may be performed on the contactless card 102 by the mobile device, and the contactless card 102 may generate and provide the message to the device. For example, once within range, the contactless card 102 and the device may perform one or more exchanges for the contactless card 102 to send the message to the device.

The wireless communication may be in accordance with a wireless protocol, such as near-field communication (NFC), Bluetooth®, Wi-Fi, and the like. In some instances, a message may be communicated between a contactless card 102 and a device via wired means, e.g., via the contact pad, and in accordance with the EMV protocol.

As discussed above, the contactless card 102 may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card 102. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacturer, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc, may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card 102 stores the generated application key(s) or UDK(s).

In embodiments, the contactless card 102 utilizes the application key(s) or UDK(s) to generate session keys for each encrypted data is generated. The following is one processing flow that may be performed by the contactless to generate a unique cryptogram session key (ASK).

To generate the ASK, the contactless card 102 computes SKL by encrypting [ATC[2]∥ATC[3]∥‘F0’∥‘00’|[ATC[0]∥[ATC[1]∥[ATC[2]∥[ATC[3]] with an application key. Further, the contactless card 102 computes SKR by encrypting [ATC[2]∥ATC[3]∥‘0F’∥‘00’∥[ATC[0]∥[ATC[1]∥[ATC[2]∥[ATC[3]] with the application key. Finally, the contactless card 102 concatenates SKL with SKR to form an authentication session key (ASK). In embodiments, the ASK is used to perform operations utilizing the contactless card 102, such as encrypting the cryptographic MAC.

In embodiments, the contactless card 102 also supports session key derivation to generate a unique encipherment session key DESK. The contactless card 102 computes an SKL by encrypting [ATC[2]∥ATC[3]∥‘F0’∥‘00’∥‘00’∥‘00’∥‘00’∥‘00’] with a Data Encryption Key (DEK) or UDK. Further, the contactless card 102 computes SKR by encrypting [ATC[2]∥ATC[3]∥‘0F’∥‘00’∥‘00’∥‘00’∥‘00’∥‘00’] with the DEK or UDK. The contactless card 102 concatenates SKL with SKR to form the Data Encipherment Session Key (DESK).

In embodiments, the contactless card 102 generates encrypted data or a cryptogram utilizing the session keys. Specifically, the contactless card 102 generates a cryptogram C by calculating a MAC over the 32-byte transaction data T using the Authentication Session Key (ASK).

The contactless card 102 may process the data to generate the cryptogram. Specifically, the contactless card 102 divides T into four blocks of 8 bytes of data: T=T1∥T2∥T3∥T4. The contactless card 102 computes B=DES(ASKL) [T1], where is the Data Encryption Standard or another symmetric encryption algorithm, ASKL is a portion of the ASK, e.g., the “left” half of the key. The contactless card 102 computes B=[B XOR T2], and, the contactless card 102 computes B=DES(ASKL) [B], where DES is an encryption algorithm. The contactless card 102 computes B=[B XOR T3], and the contactless card 102 computes B=DES(ASKL) [B]. The contactless card 102 computes B=[B XOR T4], and the contactless card 102 computes B=DES(ASKL) [B]. The contactless card 102 computes B=DES⁻¹(ASKR) [B], where DES⁻¹ is the reciprocal DES operation, and ASKR is a portion of the ASK, e.g., the right half. The contactless card 102 computes the cryptogram C=DES(ASKL) [B].

In embodiments, a contactless card 102 may also encipher the cryptogram to secure the data further. For example, a contactless card 102 may generate an 8-byte random number [RND] and the card computes E1=DES3(DESK) [RND], where DES3 is a symmetric encryption algorithm such as the Triple Data Encryption Standard. The contactless card 102 then computes B=[E1] XOR [C], where C is the cryptogram generated, as discussed above. The contactless card 102 computes E2=DES3(DESK) [B], where B is computed above. Further, the contactless card 102 generates the 16-byte enciphered payload E=[E1]∥[E2].

In embodiments, a device or the contactless card 102 may decrypt the payload E by determining, receiving, or retrieving the payload E. The device computes a RND=DES3⁻¹(DESK) [E1]. The device determines B=DES3⁻¹(DESK) [E2], and the device computes C=[E1] XOR [B].

In embodiments, the contactless generates or calculates a message authentication code (MAC). In some instances, the MAC may be an updated MAC. In embodiments, the updated MAC is included in data communicated from a contactless card 102 to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes)∥Update Date Time (8 bytes)∥‘80’∥‘00 00 00 00 00’]. For the calculations, the data may be divided into two separate portions. Specifically, the data U is broken into two blocks of 8 bytes of data, where U=U₁∥ U₂. Further, operations may be performed on U₁ and U₂.

Embodiments include applying an algorithm to the first portion (U₁) of the data. In one example, a result B may be computed where B=DES(MCKL) [U1], where DES is a Data Encryption Standard algorithm using a first portion (L) of the MAC Card Key (MCKL).

Further, an additional operation may be performed on the result B. Specifically, the result B may be exclusively or'd (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

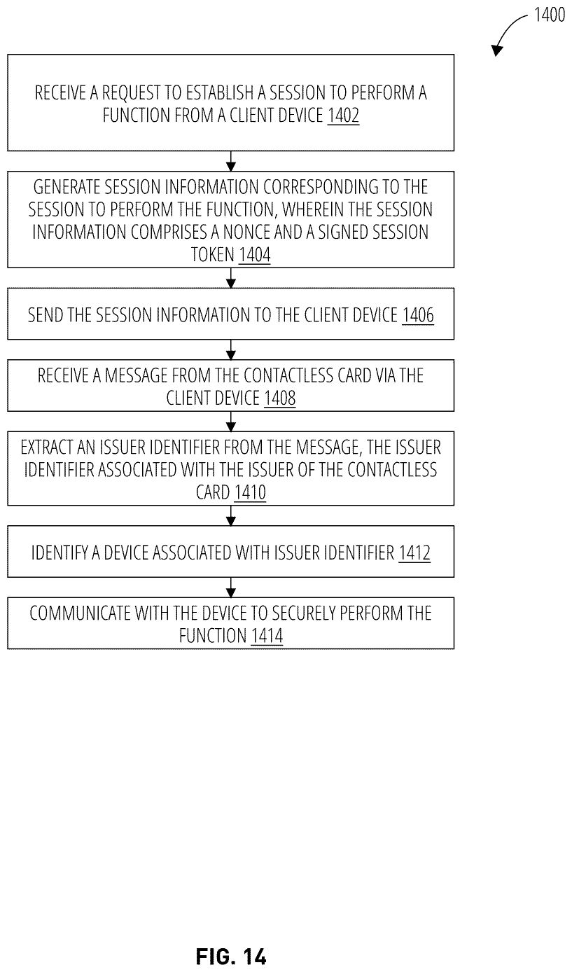

FIG. 14 illustrates an example of method 1400 in accordance with embodiments discussed herein. The method 1400 includes operations for establishing a session between the system 1000 and the location server 108 to authenticate the identity of the user 302 by validating the encrypted data from the contactless card 102. In block 1402, the method 1400 includes receiving, by a node in a system, a request to establish a session to perform a function from a client device, wherein the function is at least partially performed utilizing a contactless card, such as contactless card 102. In some instances, the node may be one of a plurality nodes of a switchboard system. The node may be previously selected by the sending device via a DNS operation performed.

In block 1404, the method 1400 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card is authenticated, and to keep track of the session for the function.

In block 1406, method 1400 includes sending the session information to the client device by the node. The client device may communicate with a contactless card to receive data from the card to authenticate and perform a function. In some instances, the client device may send the nonce from the node to the contactless card. The contactless card may utilize the nonce when generating the message to communicate back to the client device. Finally, the node, e.g., incorporates it into a cryptographic portion of the message (see FIG. 13).

In block 1408, method 1400 includes receiving, by the node, a message from the contactless card via the client device. The message may be generated by the contactless card. FIG. 13 illustrates one example of a message 1300. In some embodiments, the node verifies the message. For example, the node may verify a nonce in the message and a signed session token.

In block 1410, method 1400 extracts an issuer identifier from the message by the node, the issuer identifier associated with the issuer of the contactless card. In some instances, the issuer identifier may be in a plaintext format.

In block 1412, method 1400 identifies, by the node, a device associated with the issuer identifier. For example, the node may perform a lookup to determine a server associated with the issuer identifier and the function to be performed.

In block 1414, method 1400 communicates, by the node, with the device to securely perform the function.

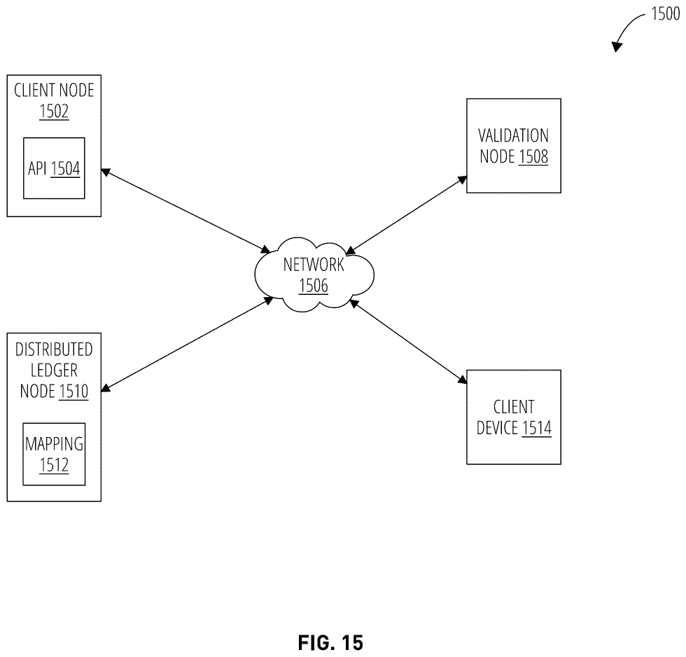

FIG. 15 illustrates a distributed network authentication system 1500 according to an example embodiment. As further discussed below, system 1500 can include client node 1502, API 1504, network 1506, distributed ledger node 1510, mapping 1512, and client device 1514. Although FIG. 15 illustrates single instances of the components, system 1500 can include any number of components.

System 1500 can include a client node 1502, which can be a network-enabled computer as described herein. In some examples, client node 1502 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1500.

In some examples, client node 1502 can execute one or more applications, such as software applications, that enable, for example, network communications with one or more components of system 1500, transmit and/or receive data, and perform the functions and processes described herein.

The client node can contain an API 1504. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1504 to interact with the service, such as by performing a remote call to an API for interacting with a web-based service.

API 1504 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1502 can communicate with one or more other components of system 1500 either directly or via network 1506. Network 1506 can comprise one or more of a wireless network, a wired network or any combination of wireless network and wired network, and may be configured to connect the components of system 1500. While FIG. 15 illustrates communication between the components of system 1500 through network 1506, it is understood that any component of system 1500 can communicate directly with another component of system 1500, e.g., without involving network 1506.

System 1500 can include a validation node 1508, which can be a network-enabled computer as described herein. In some examples, validation node 1508 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1500.

In some examples, validation node 1508 can execute one or more applications, such as software applications, that enable, for example, network communications with one or more components of system 1500, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1500 can include a distributed ledger node 1510, which can be a network-enabled computer as described herein. In some examples, distributed ledger node 1510 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1500.

In some examples, distributed ledger node 1510 can execute one or more applications, such as software applications, that enable, for example, network communications with one or more components of system 1500, transmit and/or receive data, and perform the functions and processes described herein.

Distributed ledger node 1510 can containing a mapping 1512. In some examples, mapping 1512 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1500, or the one or more databases can be hosted externally to any component of the system 1500. In some examples, the one or more databases can be contained in the distributed ledger node 1510, and in other examples the one or more databases can be stored outside of distributed edger node 1510 but in data communication with distributed ledger node 1510. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1510. In other examples, the one or more databases can be remote from distributed ledger node 1510 but in data communication with distributed ledger node 1510. Data communication between the one or more databases and distributed ledger node 1510 can be a direct data communication or data communication via a network, such as the network 1506.

In some examples, client node 1502 can be in data communication with distributed ledger node 1510. Distributed ledger node 1510 can contain mapping 1512. Mapping 1514 may include, e.g., a mapping between a validation node address and the validation node 1508, a mapping between a routing number and a validation node address, and/or a mapping between a routing number and validation node 1508. In some examples, mapping 1512 can include a digital signature associated with an entity having permission to validate for a routing number. Based on one or more of these associations, client node 1502 can call validation node for validation and/or provide direction to the client device to reach the appropriate validation node. This can be accomplished by calling a validation API associated with validation node 1508.

In some examples, iterations of the mappings described herein, such as mapping 1512, can also include a software or applet version number. The version number can be used to identify a validation node or validation node address or choose between multiple validation addresses for one validation node.

In some examples, client node 1502 and distributed ledger node 1510 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1510 can update mapping 1512 to reflect a different association between, e.g., a routing number, a validation node address, and a validation node. In some examples, degrees of permissions can be issued. For example, if client node 1502 were to function to route data to validation node 1508 (or other validation nodes), client node 1502 can be given a certain level of permissions. As another example, if distributed ledger node 1510 were to have the capability to update mapping 1512, distributed ledger node 1510 can have a different, higher level of permissions.

System 1500 can include a client device 1514, which can be a network-enabled computer as described herein. In some examples, distributed ledger node 1514 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1500. Client device 1514 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1514 can be in data communication with another network-enabled computer not shown in FIG. 15, such as a smart card (e.g., a contactless card or a contact-based card).

In some examples, client device 1514 can execute one or more applications, such as software applications, that enable, for example, network communications with one or more components of system 1500, transmit and/or receive data, and perform the functions and processes described herein.

In some examples, upon receipt of an authentication request, client device 1514 can call (e.g., via an API) client node 1502. The call can include a routing number and/or an applet or software version number, and client node 1502 can query distributed ledger node 1510 and mapping 1512. Once the query returns the identification of a validation node (e.g., validation node 1508) and/or a validation node address associated with that routing number and/or applet or software version, client node 1502 can reply to client device 1514. Client device 1514 can then proceed with authentication with the validation node. The authentication can be performed by, e.g., the systems and methods described herein, such as by the generation, encryption, transmission, decryption, and validation of a cryptogram as described herein.

In some examples, client node 1502 can be co-resident with validation node 1508. In these examples, client node 1502 can handle the authentication in a single call from client device 1514. In some examples, this can be acceptable only if it is permissible for the full authentication transmission (e.g., a cryptogram as described herein) to be sent to client nodes that are not involved in authentication.

In some examples, if client node 1502 receives, from client device 1514, a routing number that is not handled by its location, client node 1502 can return a code indicating that this routing number is not handled, along with validation node address for the responsible validation node. Client device 1514 can then send the full authentication transmission to validation node 1508 using the received validation node address.

In some examples, client node 1502 can enter the distributed network with different permissions. For example, client node 1502 can be a read-only router of data. As another example, client node 1502 can have permission to send messages to distributed ledger node 1510 updating one or more routing paths for one or more routing numbers. However, client node 1502 would be prevented from updating one or more routing paths for one or more routing numbers for other entities that control other routing numbers which are not associated with client node 1502 or that did not grant this permission. As another example, distributed ledger node 1510 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 1502, distributed ledger node 1510, and/or validation node 1508, if security, legal, and/or financial conditions are met, however, delegation is not required.

In some examples, one or more APIs can facilitate communication between components of system 1500 via network 1506. In other examples, one or more APIs are not required. Rather, the components of system 1500 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could established for nodes performing mapping and/or authentication functions. As another example, a routing API, a mapping API, and a validation API can be established, which can allow for the same device or hardware configuration to perform these functions. However, the use of keys, including secret keys by validation node 1508 for authentication, can require storage of the keys in one or more HSMs, to promote key security and ensure that the keys are never entered into memory.

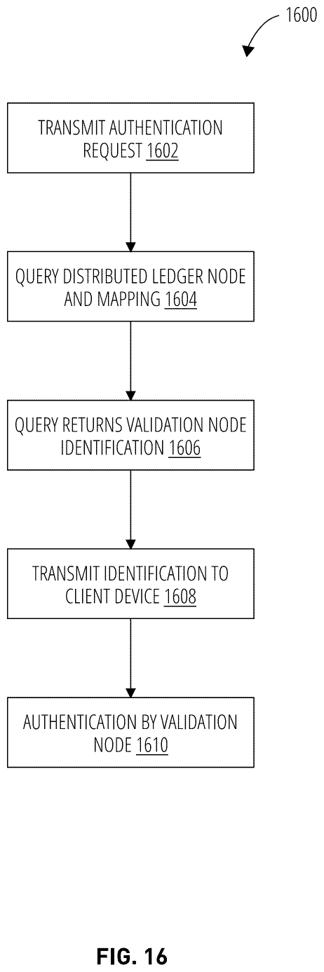

FIG. 16 illustrates a method 1600 performed by a distributed network authentication system according to an example embodiment. For example, the method can be performed by distributed network authentication system 1500 and or by another distributed network authentication system.

In block 1602, a client device can transmit an authentication request to a client node. The authentication request can include, without limitation, a routing number, a software version number, and/or an applet version number. The request can be made by an API call or other communication between the client device and the client node.

In block 1604, after receiving the authentication request, the client node can transmit a query (e.g., via an API call) to a distributed ledger node. The distributed ledger node contain a mapping, and the distributed ledger node can submit the query to the mapping.

In block 1606, the query can return an identification of a validation node and/or a validation node address, and the distributed ledger node can transmit this identification to the client node.

In block 1608, the client node can transmit the identification to the client device. After receiving the identification, the client device can proceed with authentication with the identified validation node and/or validation node address, in block 1610.

The various elements of the devices as previously described with reference to FIGS. 1-16 may include various hardware elements, software elements, or a combination of both.

Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method comprising:
receiving, at a processor of a mobile device, a request to identify a location of the mobile device;
causing, by the processor, a prompt to be displayed on the mobile device to tap a contactless card associated with a user account to the mobile device based on the request;
receiving, by the processor, encrypted data from the contactless card based on the contactless card being within a communication range of the mobile device;
gathering, by the processor, location data of the mobile device from one or more electrical components in proximity of the mobile device; and
sending, by the processor, the encrypted data from the contactless card and the location data to one or more servers to verify the encrypted data and determine the location of the mobile device within an area based on the location data.

2. The method of claim 1, wherein the one or more electrical components includes one or more wireless access points (WAPs); and
wherein the location data includes a list of one or more service set identifiers (SSIDs), each SSID associated with a corresponding WAP, that the mobile device is connectable with at a time the contactless card is tapped to the mobile device.

3. The method of claim 2, wherein the location data further includes a wireless fidelity (Wi-Fi) signal strength of each SSID in the list, the Wi-Fi signal strength gathered from Wi-Fi settings or a Wi-Fi antenna system on the mobile device.

4. The method of claim 2, further comprising:
updating, by the processor, the list periodically and sending the updated list to the one or more servers, where the list of one or more SSIDs and corresponding Wi-Fi signal strengths for each SSID is dynamically updated to indicate available SSIDs and Wi-Fi signal strengths as the mobile device moves within the area.

5. The method of claim 1, wherein the electrical components include one or more radio frequency identification (RFID) or near-field communication (NFC) readers that provide location data of the RFID or NFC reader within the area; and
wherein gathering the location data includes bringing the mobile device in close proximity of the RFID or NFC reader to receive the location data thereof within the area.

6. The method of claim 1, further comprising:
receiving, at the processor, an access code from one of the one or more servers based on the determined location of the mobile device, the access code for accessing a space within the area; and
sending, by the mobile device, the access code to a controller of a door to thereby allow access to the space within the area.

7. The method of claim 1, wherein the encrypted data includes an identity token that is unique to the contactless card and is decrypted by the one or more servers to verify an identity of a user of the contactless card.

8. The method of claim 1, further comprising:
receiving, at the processor, instructions from the one or more servers on how to navigate within the area from the location of the mobile device to a second location; and
displaying, by the processor, the instructions or a graphic representation of the instructions on a user interface of the mobile device for a user to navigate within the area.

9. A server comprising:
a memory storing executable instructions;
a processing circuit to execute the instructions, which when executed cause the processing circuit to:
send, to a mobile device, a request to identify a location of the mobile device within an area, the request configured to cause a prompt to be displayed on the mobile device to tap a contactless card associated with a user to the mobile device, wherein the contactless card is to send encrypted data to the mobile device during the tap;
receive from the mobile device location data thereof; and
communicate with an authentication server that the encrypted data is authenticated;
determine, based on the location data, a location of the mobile device within the area; and
store the location of the mobile device in a data store.

10. The server of claim 9, wherein the processing circuit is further caused to display an indicator at the location of the mobile device on a digital map of the area.

11. The server of claim 9, wherein the location data includes a list of one or more service set identifiers (SSIDs), each SSID associated with a corresponding WAP, that the mobile device is connectable with at a time the contactless card is tapped to the mobile device.

12. The server of claim 11, wherein the location data further includes a wireless fidelity (Wi-Fi) signal strength of each SSID in the list, the Wi-Fi signal strength gathered from Wi-Fi settings or a Wi-Fi antenna system on the mobile device.

13. The server of claim 12, wherein the processing circuit is further caused to:
access a Wi-Fi range map for the area that includes each of the WAPs in the area, the Wi-Fi range map including estimated signal strength for each WAP at different locations in the area; and
determine the location of the mobile device based on the list of one or more SSIDs and corresponding Wi-Fi signal strengths received from the mobile device and based on the Wi-Fi range map of the area.

14. The server of claim 13, wherein the processing circuit is further caused to receive a plurality of lists with dynamically updated SSIDs and corresponding Wi-Fi signal strengths for available WAPs as the mobile device moves; and
wherein the processing circuit is further caused to determine a movement of the mobile device based on the plurality of lists and the dynamically updated SSIDs and corresponding Wi-Fi signal strengths.

15. The server of claim 9, wherein the location data of the mobile device includes location data from a radio frequency identification (RFID) or near-field communication (NFC) reader; and
wherein the processing circuit is caused to receive the location data from the RFID or NFC reader after the mobile device scans the RFID or NFC reader after the contactless card is tapped, the location data from the RFID or NFC reader indicating a location thereof within the area.

16. A method comprising:
sending, by a location server, to a mobile device a request to identify a location of the mobile device, the request configured to cause a prompt to be displayed on the mobile device to tap a contactless card associated with a user to the mobile device, wherein the contactless card is to send encrypted data to the mobile device for forwarding to an authentication server;
receiving, by the location server from the mobile device, location data thereof;
receiving, by the location server from the authentication server, an indication that the encrypted data has been validated along with an identity of a user associated with the contactless card;
analyzing, by the location server, the location data to determine a location of the mobile device within an area;
determining, by the location server, instructions for navigating within the area from the location of the mobile device to a second location; and
sending, by the location server, the instructions to the mobile device for display to the user.

17. The method of claim 16, further comprising causing, by the location server, an access code to be sent to the mobile device, the access code for gaining access to the second location or another space within the area.

18. The method of claim 16, wherein the location data includes a list of one or more service set identifiers (SSIDs), each SSID associated with a corresponding WAP, that the mobile device is connectable with at a time the contactless card is tapped to the mobile device; and
wherein the location data further includes a wireless fidelity (Wi-Fi) signal strength of each SSID in the list, the Wi-Fi signal strength gathered from Wi-Fi settings or a Wi-Fi antenna system on the mobile device.

19. The method of claim 18, further comprising:
accessing, by the location server, a Wi-Fi range map for the area that includes each of the WAPs in the area, the Wi-Fi range map including estimated signal strength for each WAP at different locations in the area; and
determining, by the location server, the location of the mobile device based on the list of one or more SSIDs and corresponding Wi-Fi signal strengths received from the mobile device and based on the Wi-Fi range map of the area.

20. The method of claim 16, further comprising storing the location of the mobile device in a data store that includes a plurality of current locations stored therein, each of the plurality of locations corresponding to the location of a different mobile device located within the area.
